(19) United States
(12) Patent Application Publication
(10) Pub. No.: US 2026/0089721 A1
(43) Pub. Date: Mar. 26, 2026

(54) TECHNIQUES FOR DIFFERENTIATION IN HARQ PROCESS TYPES

(71) Applicant: QUALCOMM Incorporated, San Diego, CA (US)

(72) Inventors: Linhai HE, San Diego, CA (US); Sitaramanjaneyulu KANAMARLAPUDI, San Diego, CA (US)

(21) Appl. No.: 19/330,651

(22) Filed: Sep. 16, 2025

Related U.S. Application Data
(60) Provisional application No. 63/698,481, filed on Sep. 24, 2024.

(51) Int. Cl. H04W 72/21; H04L 1/1867

(52) U.S. Cl. CPC H04W 72/21; H04L 1/1896

(57) ABSTRACT

Methods, systems, and devices for wireless communications are described. A user equipment (UE) may receive control signaling indicating an uplink grant and a hybrid automatic repeat request (HARQ) process type for the uplink grant, where the HARQ process type is one of a set of HARQ process types usable for wireless communications between the UE and a network entity, and where the HARQ process type is usable for one or more logical channels from a set of logical channels. The UE may then generate and transmit an uplink message based on the uplink grant and the HARQ process type, where the uplink message includes uplink data associated with the one or more logical channels of the HARQ process type.

### CROSS REFERENCES

The present Application for Patent claims benefit of U.S. Provisional Patent Application No. 63/698,481 by HE et al., entitled “TECHNIQUES FOR DIFFERENTIATION IN HARQ PROCESS TYPES,” filed Sep. 24, 2024, assigned to the assignee hereof, and expressly incorporated herein.

### FIELD OF TECHNOLOGY

The following relates to wireless communications, including techniques for differentiation in hybrid automatic repeat request (HARQ) process types.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems utilize various processes to improve the efficiency and reliability of wireless communications, such as hybrid automatic repeat request (HARQ) processes. In some wireless communications systems, HARQ processes are agnostic with respect to different types of communications and quality of service (QoS) requirements. That is, different channels and/or QoS flows may exhibit varying reliability and latency requirements, but may still utilize the same HARQ process (e.g., use the same HARQ Tx parameters).

### SUMMARY

The systems, methods, and devices of this disclosure each have several innovative aspects, no single one of which is solely responsible for the desirable attributes disclosed herein.

A method by a user equipment (UE) is described. The method may include receiving, from a network entity, control signaling indicating an uplink grant and at least one of an uplink grant type or a hybrid automatic repeat request (HARQ) process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, correspond to one or more logical channels (LCHs) from a set of multiple LCHs, generating an uplink message based on the uplink grant and at least one of the uplink grant type or the HARQ process type, where the uplink message includes uplink data associated with the one or more LCHs corresponding to the uplink grant type or the HARQ process type, and transmitting, to the network entity, the uplink message based on generating the uplink message.

A UE is described. The UE may include one or more memories storing processor executable code, and one or more processors coupled with the one or more memories. The one or more processors may individually or collectively be operable to execute the code to cause the UE to receive, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of uplink grant types usable for the wireless communications between the UE and the network entity, and where the HARQ process type or the uplink grant type, or both, correspond to one or more LCHs from a set of multiple LCHs, generate an uplink message based on the uplink grant and at least one of the uplink grant type or the HARQ process type, where the uplink message includes uplink data associated with the one or more LCHs corresponding to the uplink grant type or the HARQ process type, and transmit, to the network entity, the uplink message based on generating the uplink message.

Another UE is described. The UE may include means for receiving, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of uplink grant types usable for the wireless communications between the UE and the network entity, and where the HARQ process type or the uplink grant type, or both, correspond to one or more LCHs from a set of multiple LCHs, means for generating an uplink message based on the uplink grant at least one of the uplink grant type or and the HARQ process type, where the uplink message includes uplink data associated with the one or more LCHs corresponding to the uplink grant type or the HARQ process type, and means for transmitting, to the network entity, the uplink message based on generating the uplink message.

A non-transitory computer-readable medium storing code is described. The code may include instructions executable by one or more processors to receive, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of uplink grant types usable for the wireless communications between the UE and the network entity, and where the HARQ process type or the uplink grant type, or both, correspond to one or more LCHs from a set of multiple LCHs, generate an uplink message based on the uplink grant at least one of the uplink grant type or and the HARQ process type, where the uplink message includes uplink data associated with the one or more LCHs corresponding to the uplink grant type or the HARQ process type, and transmit, to the network entity, the uplink message based on generating the uplink message.

Some examples of the method, UEs, and non-transitory computer-readable medium described herein may further include operations, features, means, or instructions for identifying the one or more LCHs associated with the uplink grant type or the HARQ process type based on one or more characteristics associated with the one or more LCHs, the uplink data of the one or more LCHs, or both, where generating the uplink message in accordance with at least one of the uplink grant type or the HARQ process type may be based on identifying the one or more LCHs corresponding to the uplink grant type or the HARQ process type.

Some examples of the method, UEs, and non-transitory computer-readable medium described herein may further include operations, features, means, or instructions for receiving, via the control signaling, an indication of the one or more characteristics, where identifying the one or more LCHs, generating the uplink message, or both, may be based on receiving the indication of the one or more characteristics.

In some examples of the method, UE, and non-transitory computer-readable medium described herein, the one or more characteristics associated with the one or more LCHs include a link quality metric associated with the one or more LCHs.

In some examples of the method, UEs, and non-transitory computer-readable medium described herein, the one or more characteristics associated with the uplink data of the one or more LCHs include a remaining time associated with the uplink data.

Some examples of the method, UEs, and non-transitory computer-readable medium described herein may further include operations, features, means, or instructions for receiving a LCH prioritization (LCP) restriction policy associated with the UE, where the LCP restriction policy indicates an association between the set of multiple HARQ process types and corresponding sets of LCHs, where the uplink message may be generated in accordance with the LCP restriction policy.

In some examples of the method, UEs, and non-transitory computer-readable medium described herein, each HARQ process type from the set of multiple HARQ process types may be associated with a respective set of HARQ transmission parameters.

In some examples of the method, UEs, and non-transitory computer-readable medium described herein, each respective set of HARQ transmission parameters includes at least a quantity of HARQ retransmissions or a block error rate (BLER) metric.

In some examples of the method, UEs, and non-transitory computer-readable medium described herein, the control signaling includes a downlink control information (DCI) message, a radio resource control (RRC) message, or both.

In some examples of the method, UEs, and non-transitory computer-readable medium described herein, receiving the control signaling may include operations, features, means, or instructions for receiving an RRC message indicating associations between the set of multiple HARQ process types and corresponding sets of LCHs and receiving a DCI message indicating the uplink grant and the HARQ process type from the set of multiple HARQ process types that may be to be used for the uplink grant, where generating the uplink message, transmitting the uplink message, or both, may be based on receiving the RRC message and the DCI message.

In some examples of the method, UEs, and non-transitory computer-readable medium described herein, the uplink grant type is associated with a Packet Data Unit (PDU) session, where the one or more LCHs correspond to the PDU session.

In some examples of the method, UEs, and non-transitory computer-readable medium described herein, the uplink grant type is associated with a network slice, where the one or more LCHs correspond to the network slice.

In some examples of the method, UEs, and non-transitory computer-readable medium described herein, the uplink grant type is associated with a delay-sensitive quality of service (QoS) flow, where the one or more LCHs correspond to the delay-sensitive QoS flow.

Some examples of the method, UEs, and non-transitory computer-readable medium described herein may further include operations, features, means, or instructions for receiving an RRC message indicating a correspondence between the set of multiple uplink grant types usable for wireless communications between the UE and the network entity and a first set of indexes or between the set of multiple HARQ process types and a second set of multiple indexes, or both, where the control signaling indicates the uplink grant type or the HARQ process type based on the control signaling including one or more indexes that correspond to the uplink grant type or the HARQ process type, or both.

A method for wireless communications by a network entity is described. The method may include transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs and receiving, from the UE, an uplink message based on the uplink grant and at least one of the uplink grant type or the HARQ process type, where the uplink message includes uplink data associated with the one or more LCHs corresponding to the uplink grant type or the HARQ process type.

A network entity for wireless communications is described. The network entity may include one or more memories storing processor executable code, and one or more processors coupled with the one or more memories. The one or more processors may individually or collectively be operable to execute the code to cause the network entity to transmit, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs and receive, from the UE, an uplink message based on the uplink grant and at least one of the uplink grant type or the HARQ process type, where the uplink message includes uplink data associated with the one or more LCHs corresponding to the uplink grant type or the HARQ process type.

Another network entity for wireless communications is described. The network entity may include means for transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs and means for receiving, from the UE, an uplink message based on the uplink grant and at least one of the uplink grant type or the HARQ process type, where the uplink message includes uplink data associated with the one or more LCHs corresponding to the uplink grant type or the HARQ process type.

A non-transitory computer-readable medium storing code for wireless communications is described. The code may include instructions executable by one or more processors to transmit, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs and receive, from the UE, an uplink message based on the uplink grant and at least one of the uplink grant type or the HARQ process type, where the uplink message includes uplink data associated with the one or more LCHs corresponding to the uplink grant type or the HARQ process type.

In some examples of the method, network entities, and non-transitory computer-readable medium described herein, the one or more LCHs associated with the uplink grant type or the HARQ process type may be based on one or more characteristics associated with at least one of the uplink grant type or the one or more LCHs, the uplink data of the one or more LCHs, or both.

Some examples of the method, network entities, and non-transitory computer-readable medium described herein may further include operations, features, means, or instructions for transmitting, via the control signaling, an indication of the one or more characteristics, where receiving the uplink message may be based on receiving the indication of the one or more characteristics.

In some examples of the method, network entities, and non-transitory computer-readable medium described herein, the one or more characteristics associated with the one or more LCHs include a link quality metric associated with the one or more LCHs.

In some examples of the method, network entities, and non-transitory computer-readable medium described herein, the uplink grant type and the one or more LCHs are associated with a PDU session, a network slice, a delay-sensitive QoS flow, or any combination thereof.

In some examples of the method, network entities, and non-transitory computer-readable medium described herein, the one or more characteristics associated with the uplink data of the one or more LCHs includes a remaining time associated with the uplink data.

Some examples of the method, network entities, and non-transitory computer-readable medium described herein may further include operations, features, means, or instructions for transmitting a LCP restriction policy associated with the UE, where the LCP restriction policy indicates an association between the set of multiple HARQ process types and corresponding sets of LCHs, where the uplink message may be based on the LCP restriction policy.

In some examples of the method, network entities, and non-transitory computer-readable medium described herein, each HARQ process type from the set of multiple HARQ process types may be associated with a respective set of HARQ transmission parameters.

In some examples of the method, network entities, and non-transitory computer-readable medium described herein, each respective set of HARQ transmission parameters includes at least a quantity of HARQ retransmissions or a BLER metric.

In some examples of the method, network entities, and non-transitory computer-readable medium described herein, the control signaling includes a DCI message, an RRC message, or both.

In some examples of the method, network entities, and non-transitory computer-readable medium described herein, transmitting the control signaling may include operations, features, means, or instructions for transmitting an RRC message indicating associations between the set of multiple HARQ process types and corresponding sets of LCHs and transmitting a DCI message indicating the uplink grant and the HARQ process type from the set of multiple HARQ process types that may be to be used for the uplink grant, where receiving the uplink message may be based on transmitting the RRC message and the DCI message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for differentiation in hybrid automatic repeat request (HARQ) process types in accordance with one or more aspects of the present disclosure.

FIG. 2 shows an example of a wireless communications system that supports techniques for differentiation in HARQ process types in accordance with one or more aspects of the present disclosure.

FIG. 3 shows an example of a process flow that supports techniques for differentiation in HARQ process types in accordance with one or more aspects of the present disclosure.

FIGS. 4 and 5 show block diagrams of devices that support techniques for differentiation in HARQ process types in accordance with one or more aspects of the present disclosure.

FIG. 6 shows a block diagram of a communications manager that supports techniques for differentiation in HARQ process types in accordance with one or more aspects of the present disclosure.

FIG. 7 shows a diagram of a system including a device that supports techniques for differentiation in HARQ process types in accordance with one or more aspects of the present disclosure.

FIGS. 8 and 9 show block diagrams of devices that support techniques for differentiation in HARQ process types in accordance with one or more aspects of the present disclosure.

FIG. 10 shows a block diagram of a communications manager that supports techniques for differentiation in HARQ process types in accordance with one or more aspects of the present disclosure.

FIG. 11 shows a diagram of a system including a device that supports techniques for differentiation in HARQ process types in accordance with one or more aspects of the present disclosure.

FIGS. 12 through 17 show flowcharts illustrating methods that support techniques for differentiation in HARQ process types in accordance with one or more aspects of the present disclosure.

### DETAILED DESCRIPTION

Some wireless communications systems utilize various processes to improve the efficiency and reliability of wireless communications, such as hybrid automatic repeat request (HARQ) processes. HARQ processes utilize error detection and correction techniques to ensure that data is accurately transmitted and received between devices. In other different wireless communications systems, HARQ processes are agnostic with respect to different types of communications and quality of service (QoS) requirements. That is, different channels and/or QoS flows may exhibit varying reliability and latency requirements, but may still utilize a same HARQ process (e.g., use the same HARQ Tx parameters). For instance, wireless communications for an extended reality (XR) application, which require very high reliability and latency to implement, may utilize the same or similar HARQ process parameters as standard wireless communications with more relaxed reliability and latency requirements. Handling different channels and QoS flows with the same HARQ processes, however, may result in increased latency and decreased throughput.

Accordingly, aspects of the present disclosure are directed to techniques for differentiating different HARQ process types. In particular, aspects of the present disclosure introduce different HARQ process types with different HARQ parameters, such as different HARQ Tx parameters, where the respective HARQ process types may be applicable to (e.g., usable for) different logical channels (LCHs) and/or different QoS flows. For example, a network may define multiple HARQ process types, such as a first HARQ process type that is usable for a first set of LCHs or QoS flows, and a second HARQ process type that is usable for a second set of LCHs or QoS flows. In some examples, the network may transmit an uplink grant to a user equipment (UE), and may indicate a HARQ process type that is to be used for the uplink grant. In some examples, the UE may identify uplink data in a data buffer that corresponds to the respective LCHs and/or QoS flows of the HARQ process type, and may generate and transmit an uplink message in accordance with the uplink grant and indicated HARQ process type.

In some cases, associations between different HARQ process types and corresponding LCHs/QoS flows may be static (e.g., HARQ process type #1 is always associated with LCH #0, HARQ process type #2 is always associated with LCH #1). In other cases, the associations between the different HARQ process types and corresponding LCHs/QoS flows may be dynamic based on channel conditions, characteristics of the data to be sent, or both. For example, HARQ process type #1 may be usable for LCHs that exhibit a minimum channel quality, such that the association between HARQ process type #1 and the applicable LCHs changes over time as the channel qualities of the respective LCHs change. By way of another example, some HARQ process types may be usable for uplink data that satisfies a certain “remaining time.” For instance, HARQ process type #2 only usable for uplink data that has at least X remaining time before it must be transmitted, where HARQ process type #3 may be usable for uplink data that has less than X remaining time.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for differentiation in HARQ process types.

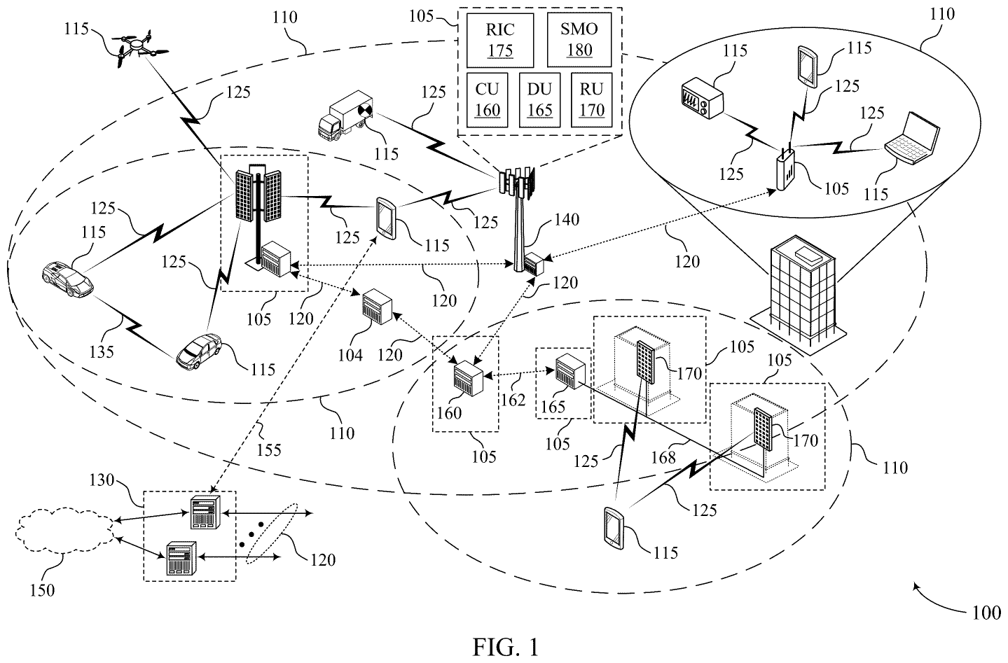

FIG. 1 shows an example of a wireless communications system 100 that supports techniques for differentiation in HARQ process types in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for differentiation in HARQ process types as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via LCHs. A MAC layer may perform priority handling and multiplexing of LCHs into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective wireless devices of the wireless communications system 100 (e.g., UEs 115, network entities 105, IoT devices, IAB nodes, etc.) may support techniques for differentiating different HARQ process types. In particular, the wireless communications system 100 may support different HARQ process types with different HARQ Tx parameters, where the respective HARQ process types may be applicable to (e.g., usable for) different logical channels (LCHs) and/or different QoS flows. For example, a network entity 105 may define multiple HARQ process types, such as a first HARQ process type that is usable for a first set of LCHs or QoS flows, and a second HARQ process type that is usable for a second set of LCHs or QoS flows. In this example, the network entity 105 may transmit an uplink grant to a UE 115, and may indicate a HARQ process type that is to be used for the uplink grant. In this example, the UE 115 may identify uplink data in a data buffer that corresponds to the respective LCHs and/or QoS flows of the HARQ process type, and may generate and transmit an uplink message in accordance with the uplink grant and indicated HARQ process type.

In some cases, associations between different HARQ process types and corresponding LCHs/QoS flows may be static (e.g., HARQ process type #1 is always associated with LCH #0, HARQ process type #2 is always associated with LCH #1). In other cases, the associations between the different HARQ process types and corresponding LCHs/QoS flows may be dynamic based on channel conditions, characteristics of the data to be sent, or both. For example, HARQ process type #1 may be usable for LCHs that exhibit a minimum channel quality, such that the association between HARQ process type #1 and the applicable LCHs changes over time as the channel qualities of the respective LCHs change. By way of another example, some HARQ process types may be usable for uplink data that satisfies a certain “remaining time.” For instance, HARQ process type #2 only usable for uplink data that has at least X remaining time before it must be transmitted, where HARQ process type #3 may be usable for uplink data that has less than X remaining time.

Techniques described herein may enable HARQ processes to be tailored to different types of communications or LCHs. For example, XR applications may be configured to utilize a first HARQ process type, and enhanced mobile broadband (eMBB) communications may be configured to utilize a second HARQ process type. In some cases, by defining associations between HARQ process types and corresponding LCHs and/or QoS flows, techniques described herein may resolve ambiguities at a UE as to which HARQ Tx parameters the UE is to use. Additionally, aspects of the present disclosure may facilitate reduced latency and increased throughput for wireless communications by tailoring HARQ process types to different LCHs/QoS flows.

LCH prioritization (LCP) may be a fundamental MAC procedure as to construction of a MAC transport block (TB) from existing radio bearers and associated data. An encoder device, such as a UE 115 generating the TB for an uplink transmission or a network entity 105 generating the TB for a downlink transmission, may prioritize LCHs based on priority of the traffic, a prioritized bit rate (PBR), and a bucket size duration (BSD). For example, RRC may control the scheduling of uplink data by signaling, for each logical channel per MAC entity, priority, PBR, and BSD. The priority, PBR, and BSD may be configured via RRC signaling.

In some cases, techniques (e.g., algorithms) to encode a MAC TB considering the multiple LCHs in some wireless communications may be statically configured. For example, the encoder may use a recursive LCH-based algorithm until the grant or data is exhausted. For example, when a new transmission is performed, the MAC entity may allocated resources to the logical channels according to logical channels with Bj>0 in a decreasing priority order. If the PBR of a logical channel is set to infinity, the MAC entity may allocate resources for all the data that is available for transmission on the logical channel before meeting the PBR of the lower priority logical channels. The MAC entity may decrement Bj by the total side of MAC service data units (SDUs) served to the logical channel j. If any resources remain, all selected logical channels may be served in a decreasing priority order (e.g., regardless of the value of Bj) until either the data for that logical channel or the uplink grant is exhausted, whichever comes first. Logical channels configured with equal priority may be served equally. If the MAC entity is requested to simultaneously transmit multiple MAC PDUs, or if the MAC entity receives multiple uplink grants with one or more coinciding physical downlink control channel (PDCCH) occasions (e.g., on different serving cells), the UE 115 may determine and/or select an order in which the uplink grants are processed.

These techniques or algorithms for LCP may be based on different PDU sessions existing for different services, different QoS requirement-based flows are mapped to different resource blocks, and different resource blocks are grouped among different LCH groups appropriate based on the traffic and characteristics of the traffic. In some cases, a QoS flow may have a resource block relation of N to 1, a resource block may have a logical channel relation of 1 to 1, and an LCH may have an LCH group relation of N to 1. For example, there may be 16 PDU sessions, 32 resource blocks, and 8 LCH groups.

However, a quantity of services and QoS requirements per QoS flow may be application-specific and may be dynamic. For example, traffic may be bursty, haptic, or have one of multiple different priority levels. In some examples, different slices (e.g., in network slicing) may have different requirements, such as service level agreement (SLA) defined end-to-end (E2E). Each network slice may have a different quantity of bearers A radio configuration from a RAN may be semi-static. There may be limited coordination of flow-level fine granularity between the RAN and the core network. Additionally, there may be challenges of various network entities 105 and associated links and buffers at each node. As such, intended QoS requirements may not be satisfied with semi-static configurations.

When an uplink grant is indicated to a UE 115, some systems may not provide for a UE 115 to be configured with a QoS flow, resource block, LCH, or LCH group, or any combination thereof, from the grant to ensure that latency and metrics (e.g., BLER key performance indicators (KPIs)) are satisfied for the QoS flow as part of the QoS requirements. QoS flow traffic may be dynamic, while the configuration for LCP may be semi-static. For example, the semi-static configuration of PBR, BSD, and Bj at the MAC level and the semi-static configuration of a relation from a QoS flow to resource blocks to LCH to LCH group at an application server configuration level may reduce user experience. In some cases, FEC may be used to afford some level of packet loss to avoid retransmission-associated delay, and FEC may be implemented at application level or be implemented with outer coding at radio level.

For some scenarios, such as XR communications where latency and BLER are significant, the wireless communications system 100 may support additional reports, such as a delay status report (DSR). Based on DSR and BSR, the network may effectively change a grant mechanism to ensure DSR traffic is met with latency in an XR service. In some cases, different slices in different scenarios may have different delay budgets and error rates that may impact extension of these techniques from service level to grant management. With semi-static configuration, to meet a DSR traffic-related PDU set error rate (PSER), the network may provide high priority grants, which may reduce communications efficiencies from the network or UE perspective.

The wireless communication system 100 may support techniques for uplink grant enhancement that provide for control signaling carrying an uplink grant to indicate an uplink grant type of the uplink grant. For example, the uplink grant type may indicate that the uplink grant is associated with a specific PDU session. For example, the uplink grant may be prioritized for a specific PDU session per LCP and remaining for other PDU sessions. Additionally, or alternatively, the uplink grant type may indicate that the uplink grant is associated with a specific QoS flow. For example, the uplink grant type may indicate that the uplink grant is DSR-specific or associated with delay sensitive traffic, or both. The uplink grant may be prioritized for a specific DSR trigger across the PDU sessions per LCP and remaining for other BSR purposes. In some example, the uplink grant type may indicate that the uplink grant is associated with a specific BSR and PDU session.

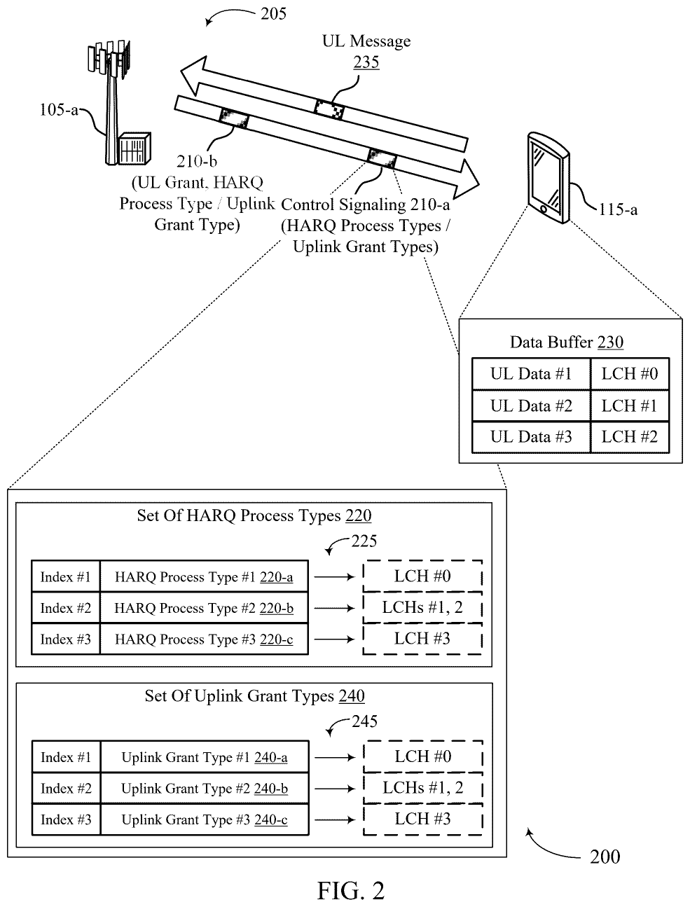

FIG. 2 shows an example of a wireless communications system 200 that supports techniques for differentiation in HARQ process types in accordance with one or more aspects of the present disclosure. In some examples, aspects of the wireless communications system 200 may implement, or be implemented by, aspects of the wireless communications system 100. In particular, the wireless communications system 200 may support multiple different HARQ process types for different sets of LCHs/QoS flows, as described herein.

The wireless communications system 200 may include a network entity 105-a and a UE 115-a, which may be examples of wireless devices as described herein. In some aspects, the network entity 105-a and the UE 11-5a may communicate with one another using a communication link 205, which may be an example of an NR or LTE link, sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205, and one or more components of the network entity 105-a may transmit downlink signals, such as downlink control signals or downlink data signals, to the UE 115-a using the communication link 205.

As noted previously herein, in some wireless communications systems (e.g., 4G/5G communications systems), HARQ processes may be agnostic with respect to different types of communications and QoS requirements. That is, different channels and/or QoS flows may exhibit varying reliability and latency requirements, but may still utilize the same HARQ process (e.g., use the same HARQ Tx parameters). For instance, wireless communications for an XR application, which require very high reliability and latency to implement the XR application, may utilize the same or similar HARQ process parameters as eMBB wireless communications with more relaxed reliability and latency requirements. Handling different channels and QoS flows with the same HARQ processes may result in increased latency and decreased throughput.

A comparison between XR control communications (with low data rate and tight delay requirement) and eMBB communications is provided in Table 1 below for reference:

TABLE 1
Comparison Between XR Control and eMBB Communications

| | XR Control | eMBB |
|---|---|---|
| Reliability | 99.999% | 99% |
| requirement | | |
| Latency requirement | ≤20 ms | ≤50 ms |
| # of HARQ ReTx | ≤5 | 2 |
| Radio Link Control | Unacknowledged | Acknowledged |
| (RLC) mode | Mode (UM) | Mode (AM) |

As shown in Table 1 above, XR control traffic is subject to higher (e.g., more stringent) reliability and latency requirements as compared to eMBB traffic. To server the XR control flow, there may be lower latency to use only HARQ retransmission (ReTx) (e.g., RLC uses UM) to serve the XR control flow. As such, the block error rate (BLER) for the XR control flow may be set to a lower target to meet the reliability requirement (e.g., BLER target may be set to 10%), which may be feasible as control traffic has low data bit rate. However, to maximize throughput for eMBB, BLER can be set to a higher target than that for XR control flow. Despite the different characteristics and requirements of the XR control flow and the eMBB flow, in some wireless communications systems, these communications/flows may utilize the same HARQ process.

With more diverse traffic, it can be beneficial to handle different QoS flows with different HARQ/RLC parameters. In other words, it may be beneficial to support differentiation in HARQ to tailor tradeoffs between latency, throughput, and reliability. Accordingly, aspects of the present disclosure are directed to techniques for differentiating different HARQ process types. In particular, aspects of the present disclosure introduce different HARQ process types with different HARQ Tx parameters, where the respective HARQ process types may be applicable to (e.g., usable for) different LCHs and/or different QoS flows. For example, a network may define multiple HARQ process types, such as a first HARQ process type that is usable for a first set of LCHs or QoS flows, and a second HARQ process type that is usable for a second set of LCHs or QoS flows. In this example, the network may transmit an uplink grant to a UE, and may indicate a HARQ process type that is to be used for the uplink grant. In this example, the UE may identify uplink data in a data buffer that corresponds to the respective LCHs and/or QoS flows of the HARQ process type, and may generate and transmit an uplink message in accordance with the uplink grant and indicated HARQ process type.

For example, referring to FIG. 2, the UE 115-a may be configured with a set of HARQ process types 220 that are usable for communications between the UE 115-a and the network entity 105-a, such as a first HARQ process type 220-a, a second HARQ process type 220-b, and a third HARQ process type 220-c. The set of HARQ process types 220 may be pre-configured at the UE 115, defined by the network and signaled to the UE 115-a, or both. For instance, in some cases, the network entity 105-a may transmit control signaling 210-a (e.g., RRC signaling, system information signaling) to the UE 115-a, where the control signaling 210-a indicates the set of HARQ process types 220.

In other words, the network may define or indicate different “types” of uplink HARQ processes, where the different HARQ process types 220 may correspond to different HARQ Tx parameters for a HARQ process (e.g., first HARQ process type 22-a is associated with a first set of HARQ Tx parameters, second HARQ process type 22-a is associated with a second set of HARQ Tx parameters, etc.). HARQ Tx parameters for the respective HARQ process types 220 may include, but are not limited to, a number/quantity of HARQ retransmissions, a BLER metric, and the like. In some cases, the respective HARQ Tx parameters for the respective HARQ process types 220 may be up to network implementation, and may or may not be specified or signaled to the UE 115-a.

In some aspects, each respective HARQ process type 220 may be associated with an index. The respective HARQ process type 220 correspond to (e.g., be usable for) a respective set of LCHs and/or QoS flows, where the relationships between the HARQ process types 220 and the corresponding LCHs/QoS flows may be defined according to a set of associations 225. For instance, the first HARQ process type 220-a may correspond to (e.g., be associated with, be usable for) LCH #0, where the second HARQ process type 220-b may correspond to (e.g., be associated with, be usable for) LCHs #1 and 2.

In this regard, the network (e.g., network entity 105-a) may configure which types of HARQ processes a LCH is allowed to use (e.g., define the associations 225 between HARQ process types 220 and corresponding LCHs/QoS flows). For example, the first HARQ process type 220-a may be used for high reliability and low latency. in such cases, LCH #0, which is reserved for signaling radio bearer (SRB) messages, may only be allowed to use the first HARQ process type 220-a. In some cases, the associations 225 between the HARQ process types 220 and the corresponding LCHs/QoS flows may be included or indicated in the configuration of a LCH prioritization (LCP) restriction policy at the UE 115-a.

In some aspects, the associations 225 between the HARQ process types 220 and the corresponding LCHs/QoS flows may be static (e.g., first HARQ process type 220-a is always associated with LCH #0, second HARQ process type 220-b is always associated with LCHs #1, 2). In other cases, the associations 225 may be dynamic based on characteristics associated with the respective LCHs/QoS flows (e.g., dynamic based on LCH link quality) and/or based on characteristics of the data to be sent (e.g., dynamic based on delay status or remaining time of the uplink data). In the case of dynamic associations 225, the respective HARQ process types 220 may be usable for different sets of LCHs or QoS flows over time as channel conditions change, as the uplink data to be transmitted changes, etc.

For example, in the context of a dynamic association 225, suppose the first HARQ process type 220-a is used for low latency communications, and the second HARQ process type 220-b is used for high-reliability communications. In this example, the associations 225 may be dynamic based on the types of communications.

By way of another example, the network may configure a remaining time threshold for an LCH such that the associations 225 between the HARQ process types 220 and corresponding LCHs are dynamic based on the characteristics of the uplink data to be sent (e.g., based on the remaining time of the uplink data). For instance, if uplink data to be communicated on LCH #0 has a remaining time (e.g., time before the data must be transmitted) above the threshold, it is allowed to use either the first HARQ process type 220-a or the second HARQ process type 220-b (e.g., association 225 between LCH #0 and both the first and second HARQ process types 220-a, 220-b). Otherwise, if the remaining time for the uplink data is less than the threshold, it is only allowed to use the first HARQ process type 220-a (e.g., association 225 between LCH #0 and only the first HARQ process type 220-a). In this regard, as the remaining time for uplink data on a given LCH changes, the HARQ process types 220 for that uplink data may also change (e.g., the associations 225 change based on the remaining time for the uplink data and corresponding LCHs for the uplink data).

Similarly, by way of another example, the network may configure a link/channel quality threshold (e.g., RSRP threshold) for an LCH such that the associations 225 between the HARQ process types 220 and corresponding LCHs are dynamic based on the characteristics the respective LCHs. For instance, if the UE 115-a measures or otherwise determines that an RSRP measurement on a configured downlink reference signal for a given LCH is above a configured RSRP threshold, the data for that LCH may be allowed to use either the second HARQ process type 220-b or the third HARQ process type 220-c (e.g., association 225 between the LCH and both the second and third HARQ process types 220-b, 220-c). Otherwise, if the RSRP measurement for the LCH is below the configured RSRP threshold, the data for that LCH may only be allowed to use the third HARQ process type 220-c (e.g., association 225 between the LCH and only the third HARQ process type 220-c). In this regard, as channel qualities for the respective LCHs change, the HARQ process types 220 for the respective LCHs may also change (e.g., the associations 225 change based on the channel qualities of the LCHs).

Continuing with reference to FIG. 2, the UE 115-a may receive additional control signaling 210-a (e.g., RRC, downlink control information (DCI)) that indicates an uplink grant for the UE 115-a (e.g., resources for transmitting an uplink message). In some aspects, the additional control signaling 210-b may additionally, or alternatively, indicate a HARQ process type 220 for the uplink grant. That is, the additional control signaling 210-b may indicate which HARQ process type 220 from the set of configured HARQ process types 220 is to be used for transmitting uplink messages 235 for the uplink grant. In the context of a dynamic grant, the network entity 105-a may indicate the HARQ process type 220 for the uplink grant in the scheduling DCI message (e.g., the DCI may use two bits to indicate the index of the applicable HARQ process type 220). Comparatively, in the context of a configured grant, the network entity 105-a may indicate the HARQ process type in the RRC configuration.

When an uplink grant becomes available (e.g., signaled) to the UE 115-a, the UE 115-a may first check the HARQ process type 220 for the uplink grant, then determine which LCHs (and/or QoS flows) are allowed to use this specific type of HARQ process type 220. As noted previously herein, in the context of dynamic associations 225, the determination of applicable LCHs may depend on characteristics of the respective LCHs (e.g., channel quality metrics of the LCHs, such as RSRP measurements performed by the UE 115-a on the respective LCHs) and/or characteristics of the data to be sent on the respective LCHs (e.g., remaining time of the uplink data to be transmitted on the respective LCHs). After determining which LCHs are eligible for the indicated HARQ process type 220 of the uplink grant, the LCHs that are eligible to use the uplink grant and which have buffered data are considered for LCP (e.g., the procedure that multiplexes data from eligible LCHs into an uplink grant). In other words, upon identifying which LCHs are eligible for the HARQ process type 220, the UE 115-a may generate an uplink message by multiplexing uplink data associated with the eligible LCHs of the HARQ process type 220.

For example, the additional control signaling 210-b may indicate an uplink grant, and may indicate that the UE 115-a is to use the first HARQ process type 220-a for the uplink grant. In this example, the UE 115-a may be configured to identify (e.g., based on static associations 225, or based on dynamic associations 225 based on characteristics of the LCHs and/or uplink data) that the first HARQ process type 220-a is associated with (e.g., usable for) LCH #0. The UE 115-a may reference a data buffer 230 to identify that the only uplink data associated with LCH #0 is UL Data #1. As such, the UE 115-a may identify that the only data from the data buffer 230 that can be transmitted according to the uplink grant and the first HARQ process type 220-a is UL Data #1. Therefore, the UE 115-a may generate an uplink message 235 that includes the UL Data #1 (based on the first HARQ process type 220-a), and may transmit the uplink message 235 within the resources of the uplink grant.

By way of another example, the additional control signaling 210-b may indicate the uplink grant, and may indicate that the UE 115-a is to use either the second or third HARQ process type 220-b, 220-c for the uplink grant. In this example, the UE 115-a may be configured to identify (e.g., based on static associations 225, or based on dynamic associations 225 based on characteristics of the LCHs and/or uplink data) that the second and third HARQ process types 220-b, 220-c are associated with (e.g., usable for) LCHs #1, 2, and 3. The UE 115-a may reference the data buffer 230 to identify that UL Data #2 and #3 are associated with LCH #1 and #2, respectively. As such, the UE 115-a may identify that UL Data #2 and #3 may be transmitted according to the uplink grant and the indicated HARQ process types 220. Therefore, the UE 115-a may generate an uplink message 235 that includes UL Data #2 and #3 (based on the second HARQ process type 220-b), and may transmit the uplink message 235 within the resources of the uplink grant.

Techniques described herein may enable the network entity 105-a to tailor different HARQ process types 220 to different types of communications or LCHs. For example, XR applications may be configured to utilize the first HARQ process type 220-a, and eMBB communications may be configured to utilize the second HARQ process type 220-b. In some cases, by defining associations between HARQ process types 220 and corresponding LCHs and/or QoS flows, techniques described herein may resolve ambiguities at the UE 115-a as to which HARQ Tx parameters the UE 115-a is to use. Additionally, aspects of the present disclosure may facilitate reduced latency and increased throughput for wireless communications by tailoring HARQ process types 220 to different LCHs/QoS flows.

In addition, or alternative to, different HARQ process types, the wireless communication system 200 may support different uplink grant types. The UE 115-a may be configured with a set of uplink grant types 240. The set of uplink grant types 240 may be usable for communications between the UE 115-a and the network entity 105-a, such as a first uplink grant type 240-a, a second uplink grant type 240-b, and a third uplink grant type 240-c. The set of uplink grant types 240 may be pre-configured at the UE 115, defined by the network and signaled to the UE 115-a, or both. For instance, in some cases, the control signaling 210-a (e.g., RRC signaling, system information signaling) may indicate the set of HARQ process types 220.

In some aspects, each respective uplink grant type 240 may be associated with an index. The respective uplink grant type 240 may correspond to (e.g., be usable for) a respective set of LCHs and/or QoS flows, where the relationships between the uplink grant type 240 and the corresponding LCHs/QoS flows may be defined according to a set of associations 245. The set of associations 245 may be similar to the set of associations 225 between HARQ process types 220 and corresponding LCHs/QoS flows. For instance, the first uplink grant type 240-a may correspond to a first QoS flow that corresponds to one or more first LCHs (e.g., LCH #0), where the second uplink grant type 240-b may correspond to (e.g., be associated with, be usable for) a second QoS flow that corresponds to one or more second LCHs (e.g., LCHs #1 and 2).

In some examples, similar to how different types of uplink HARQ processes correspond to different HARQ Tx parameters for a HARQ process, different uplink grant types may correspond to different sets of parameters (e.g., uplink Tx parameters).

An uplink grant type 240 may indicate associations or parameters for a corresponding uplink grant. For example, the uplink grant type 240 may specify whether an uplink grant is associated with a specific PDU session, network slice, or QoS flow, or any combination thereof. For example, the second uplink grant type 240-b may be associated with a specific PDU session and delay-sensitive traffic.

In some examples, an uplink grant type 240 may correspond to procedures for LCP. For example, the control signaling 210-b may include an uplink grant and an indication of an uplink grant type 240. The indication of the first uplink grant type 240 may specify that the uplink grant is associated with a specific PDU session. The UE 115-a may perform LCP based on the indication of the uplink grant type 240. For example, the UE 115-a may prioritize resources indicated by the grant for the specific PDU session per LCP, and any remaining resources from the grant may be used for other PDU sessions. In some examples, the uplink grant type may indicate that the uplink grant is associated with a specific QoS flow. The UE 115-a may prioritize resources indicated by the grant for the specific QoS flow, and any remaining resources allocated by the grant may be used for remaining QoS flows. In some examples, the uplink grant type may indicate that the uplink grant is associated with delay-sensitive traffic or a DSR. The UE 115-a may prioritize resources indicated by the uplink grant for the specific DSR trigger across PDU sessions per LCP and may use remaining resources of the uplink grant for other BSR uses.

In some examples, the UE 115-a may receive control signaling, such as RRC signaling, that configures the UE 115-a with parameters for LCP. In some examples, the configuration for LCP may include parameters or rules for LCP based on an indication of an uplink grant type. For example, the UE 115-a may utilize a grant based on configured rules in a priority order to use the grant by default. In some examples, the UE 115-a may utilize an uplink grant based on the uplink grant including information for usage of the uplink grant. In some examples, the UE 115-a may skip an uplink transmission if, for example, an uplink grant is specific to a PDU session that does not have data to transmit. In some examples, an uplink grant-related DCI may convey modulation and coding scheme (MCS) information for the UE 115-a through a cell radio network temporary identifier (C-RNTI)-based encoding. In some examples, uplink grant-related DCI may include additional bits to indicate an uplink grant type 240 from the set of uplink grant types 240. Additionally, or alternatively, the UE 115-a may determine how to utilize a grant across PDU sessions, resource blocks, or LCHs, or any combination thereof, based on an internal UE algorithm, traffic characteristics, radio conditions, or any combination thereof.

The wireless communications system 200 may support MAC grant management using multiple LCP rules. The LCP rules may, for example, be configured at a UE 115, such as the UE 115-a. The network (e.g., via the network entity 105-a) may configure the UE 115-a with the LCP rules. In some examples, the network entity 105-a may transmit RRC signaling to configure the UE 115-a with the LCP rules. In some examples, the network entity 105-a may indicate a default LCP rule. The network entity 105-a may indicate (e.g., update) the LCP rule at the UE 115-a, for example selected from the multiple LCP rules, via a MAC CE.

The wireless communications system 200 may support multiple grant usage techniques. For example, some systems may support LCH-specific grant usage. The wireless communications system 200 may support PDU session-specific grant usage, resource block-specific grant usage, QoS flow-specific grant usage, or LCH-specific grant usage, or any combination thereof. In some examples, the UE 115-a may determine or choose how to use an uplink grant received from the network entity 105-a. For example, a PDU session-specific uplink grant may enable the UE 115-a to prioritize data from a second and third PDU session (e.g., P2 and P3) of a second network slice (e.g., slice 2, which may correspond to an XR PDU session) over data from a first PDU session (e.g., P1) of a first network slice (e.g., slice 1, which may correspond to an Internet PDU session). For example, the UE 115-a may receive the control signaling 210-b including an uplink grant an indication of an uplink grant type 240 that corresponds to the second and third PDU sessions, and the UE 115-a may use the uplink grant (e.g., prioritize use of the grant) for the second and third PDU sessions over the first PDU session based on the uplink grant type 240 indicated by the control signaling 210-b.

If the UE 115-a receives a resource block-specific uplink grant, the UE 115-a may prioritize PDU session 2 data of resource block 2 compared to PDU session 1 data of resource block 1. For example, the UE 115-a may receive the control signaling 210-b including an uplink grant and an indication of an uplink grant type 240 that corresponds to resource block 2. The UE 115-a may use the uplink grant (e.g., prioritize use of the uplink grant) for the PDU session 2 data of resource block 2 compared to, for example, PDU session 1 data correspond to resource block 1 based on the uplink grant type 240 indicated by the control signaling 210-b.

In some examples, the uplink grant type may indicate for the UE 115-a to select how to use or prioritize use of an uplink grant. For example, the UE 115-a may prioritize whichever resource block, LCH, QoS flow, or PDU session, or any combination thereof, based on, for example, flow requirements or traffic of one or more applications used at the UE 115-a.

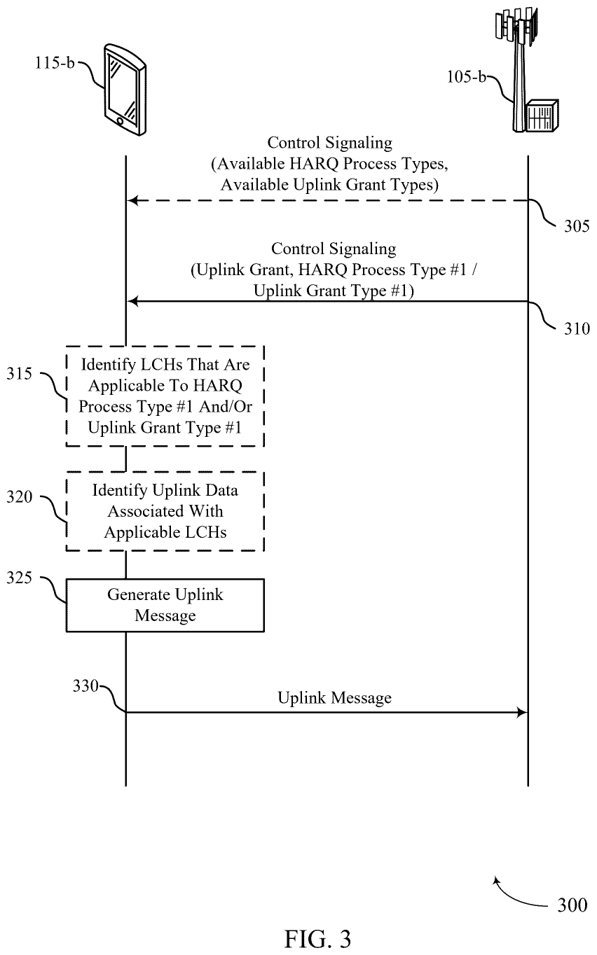

FIG. 3 shows an example of a process flow 300 that supports techniques for differentiation in HARQ process types in accordance with one or more aspects of the present disclosure. In some examples, aspects of the process flow 300 may implement, or be implemented by, aspects of the wireless communications system 100, the wireless communications system 200, or both. In particular, the process flow 300 illustrates techniques for utilizing multiple different HARQ process types for different sets of LCHs/QoS flows, as described herein.

The process flow 300 includes a network entity 105-b and a UE 115-b, which may be examples of wireless devices as described herein. For example, the network entity 105-b and the UE 115-b illustrated in FIG. 3 may include examples of the network entity 105-a and the UE 115-a, respectively, as illustrated in FIG. 2.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the UE 115-b may receive first control signaling (e.g., RRC signaling, system information signaling, etc.) that indicates a set of HARQ process types that are usable for wireless communications between the UE 115-b and the network entity 105-b. In additional or alternative cases, the UE 115-b may be pre-configured with the set of HARQ process types (e.g., without signaling from the network).

Additionally, or alternatively, the first control signaling may indicate a set of uplink grant types. The set of uplink grant types may be usable for wireless communications between the UE 115-b and the network entity 105-b. In additional or alternative cases, the UE 115-b may be pre-configured with the set of uplink grant types (e.g., without signaling from the network).

As noted previously herein, each respective HARQ process type may be associated with or correspond to (e.g., be usable for) a respective set of LCHs and/or QoS flows, where the relationships between the HARQ process types and the corresponding LCHs/QoS flows may be defined according to a set of associations (which may be defined/indicated via the first or second control signaling). For example, as shown and described in FIG. 2, the first HARQ process type 220-a may correspond to (e.g., be associated with, be usable for) LCH #0, where the second HARQ process type 220-b may correspond to (e.g., be associated with, be usable for) LCHs #1 and 2.

Each respective uplink grant type may be associated with or correspond to one or more PDU sessions, QoS flows, network slices, resource blocks, or any combination thereof. In some examples, each uplink grant type may correspond to one or more LCHs, which may be associated or used for communications for the one or more PDU sessions, the one or more QoS flows, the one or more network slices, or the one or more resource blocks that associate with or correspond to the uplink grant type.

In some cases, the associations 225 between the HARQ process types 220 and the corresponding LCHs/QoS flows may be included or indicated in the configuration of an LCP restriction policy at the UE 115-b. In some aspects, the associations 225 between the HARQ process types and the corresponding LCHs/QoS flows may be static (e.g., first HARQ process type 220-a is always associated with LCH #0, second HARQ process type 220-b is always associated with LCHs #1, 2). In other cases, the associations 225 may be dynamic based on characteristics associated with the respective LCHs/QoS flows (e.g., dynamic based on LCH link quality) and/or based on characteristics of the data to be sent (e.g., dynamic based on delay status or remaining time of the uplink data). In the case of dynamic associations 225, the respective HARQ process types 220 may be usable for different sets of LCHs or QoS flows over time as channel conditions change, as the uplink data to be transmitted changes, etc.

In some examples, the UE 115-b may receive an RRC message indicating a correspondence between the uplink grant types usable for wireless communications between the UE 115-b and the network entity 105-b and a set of indexes. In some examples, the RRC message may indicate a correspondence between the HARQ process types a second set of indexes.

At 310, the UE 115-b may receive second control signaling (e.g., RRC, DCI) that indicates an uplink grant and at least one of a HARQ process type or an uplink grant type associated with the uplink grant. For example, as shown in FIG. 3, the second control signaling may indicate that the UE 115-b is to use HARQ process type #1 (e.g., first HARQ process type 220-a) for the uplink grant. In some aspects, the UE 115-b may receive the second control signaling at 310 based on receiving the first control signaling at 305. Additionally, or alternatively, the second control signaling may indicate that the UE 115-b is to use the uplink grant type #1 (e.g., first uplink grant type 240-a) for the uplink grant type or that the uplink grant is of the first uplink grant type 240-a. In some examples, control signaling may indicate both a HARQ process type and an uplink grant type.

While the first control signaling at 305 and the second control signaling 310 are shown and described as separate signaling, this is only for the purposes of illustration. In other cases, the first control signaling 305 and the second control signaling 310 may include a single control message (e.g., RRC message).

At 315, the UE 115-b may identify the LCH(s) that are associated with (e.g., applicable to, usable for) the HARQ process type #1 or the uplink grant type #1, or both, for the uplink grant. In some aspects, the UE 115-b may identify the LCHs that are associated with the HARQ process type #1 based on an LCP restriction policy (which may be configured via the control signaling at 305). Additionally, or alternatively, the UE 115-b may identify the LCHs that are associated with the uplink grant type #1 based on the LCP restriction policy. In some aspects, the UE 115-a may identify the LCH(s) at 315 based on receiving the first control signaling at 305, receiving the second control signaling at 310, or both.

In the context of static associations 225, the UE 115-b may identify the LCH(s) that are applicable to the indicated HARQ process type #1 by referencing a table or other data object that defines the associations 225 between the HARQ process types and the corresponding LCHs (where the table/data object may be indicated via the first control signaling at 305 and/or the second control signaling at 310). Additionally, or alternatively, the UE 115-b may identify the LCH(s) that are applicable to the indicated uplink grant type #1 by referencing a table or other data object that defines the associations 245 between the uplink grant types and the corresponding LCHs (where the table/data object may be indicated via the first control signaling at 305 and/or the second control signaling at 310).

Comparatively, in the context of dynamic associations 225, the UE 115-b may identify the LCH(s) that are applicable to the indicated HARQ process type #1 by evaluating characteristics of the respective LCHs themselves, by evaluating characteristics of the uplink data to be communicated via the LCHs, or both. For example, the network may indicate that HARQ process type #1 is only usable for LCHs or QoS flows are exhibit a channel quality (e.g., RSRP) above a threshold (where the threshold may be pre-configured, signaled by the network via the control signaling at 305, 310, or both). In such cases, the UE 115-b may perform channel measurements to identify which LCHs/QoS flows satisfy the threshold, and are therefore usable for the indicated HARQ process type #1.

By way of another example, the network may indicate that the indicated HARQ process type #1 is only usable for uplink data that exhibits some criteria or characteristics, such as a remaining time above a threshold (where the threshold may be pre-configured, signaled by the network via the control signaling at 305, 310, or both). In such cases, the UE 115-b may evaluate or identify characteristics (e.g., remaining time) associated with uplink data to be transmitted in order to identify which uplink data (and corresponding LCHs/QoS flows) may be transmitted using the HARQ process type #1.

In the context of associations 245, the UE 115-b may identify the LCH(s) that are applicable to the indicated uplink grant type #1. For example, the uplink grant type #1 may correspond to one or more PDU sessions, and the UE 115-b may identify the LCH(s) as those that are usable for the one or more PDU sessions. In some examples, the uplink grant type #1 may correspond to a network slice, and the UE 115-b may identify the LCH(s) as those that are usable for, configured for, or associated with the network slice.

At 320, the UE 115-b may identify uplink data associated with the LCHs/QoS flows identified at 315. In other words, the UE 115-b may identify uplink data that is to be transmitted on the LCHs that are associated with the indicated HARQ process type #1 or the indicated uplink grant type #1, or both. In this regard, the UE 115-b may identify uplink data that is allowed to be transmitted using the HARQ process type #1 or the uplink grant type #1, or both. The UE 115-b may identify the uplink data at 320 based on receiving the control signaling at 305, receiving the control signaling at 310, identifying the applicable LCHs at 315, or any combination thereof.

At 325, the UE 115-b may generate an uplink message. In particular, the UE 115-b may generate the uplink message to be transmitted via the uplink grant, where the uplink message is associated with the LCHs that correspond to HARQ process type #1 or uplink grant type #1, or both, and includes uplink data associated with the respective LCHs. In this regard, the UE 115-b may generate the uplink message at 325 based on receiving the control signaling at 305, receiving the control signaling at 310, identifying the applicable LCHs at 315, identifying the uplink data at 320, or any combination thereof. For example, the UE 115-b may generate the uplink message by multiplexing data from multiple eligible LCHs corresponding to the HARQ process type #1 or the uplink grant type #1, or both.

At 330, the UE 115-b may transmit the uplink message to the network entity 105-b. In particular, the UE 115-b may transmit the uplink message using the set of resources associated with the uplink grant indicated at 310, and using a set of Tx parameters (e.g., HARQ Tx parameters, uplink grant Tx parameters) associated with the HARQ process type #1 or the uplink grant type #1, or both.

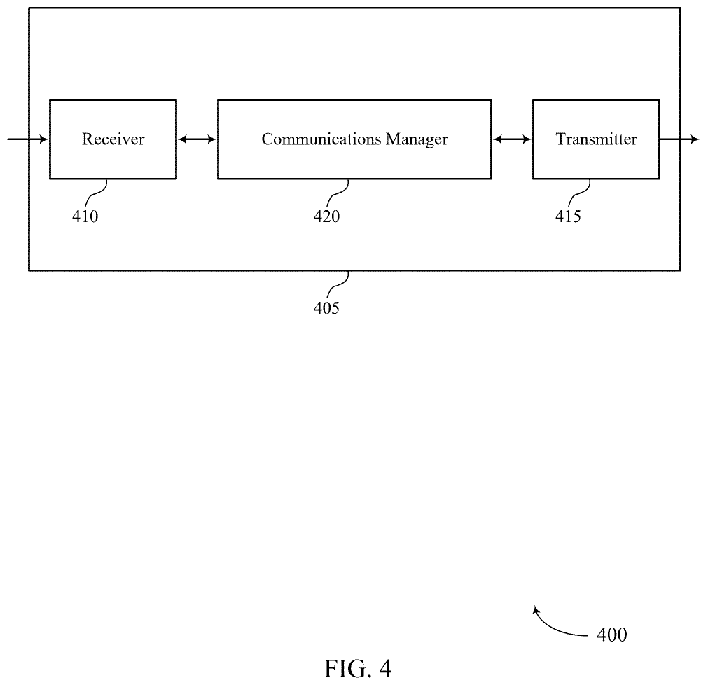

FIG. 4 shows a block diagram 400 of a device 405 that supports techniques for differentiation in HARQ process types in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for differentiation in HARQ process types). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for differentiation in HARQ process types). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for differentiation in HARQ process types as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, correspond to one or more LCHs from a set of multiple LCHs. The communications manager 420 is capable of, configured to, or operable to support a means for generating an uplink message based on the uplink grant at least one of the uplink grant type or and the HARQ process type, where the uplink message includes uplink data associated with the one or more LCHs corresponding to the uplink grant type or the HARQ process type. The communications manager 420 is capable of, configured to, or operable to support a means for transmitting, to the network entity, the uplink message based on generating the uplink message.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques that enable HARQ processes to be tailored to different types of communications or LCHs. For example, XR applications may be configured to utilize a first HARQ process type, and eMBB communications may be configured to utilize a second HARQ process type. In some cases, by defining associations between HARQ process types and corresponding LCHs and/or QoS flows, techniques described herein may resolve ambiguities at a UE as to which HARQ Tx parameters the UE is to use. Additionally, aspects of the present disclosure may facilitate reduced latency and increased throughput for wireless communications by tailoring HARQ process types to different LCHs/QoS flows.

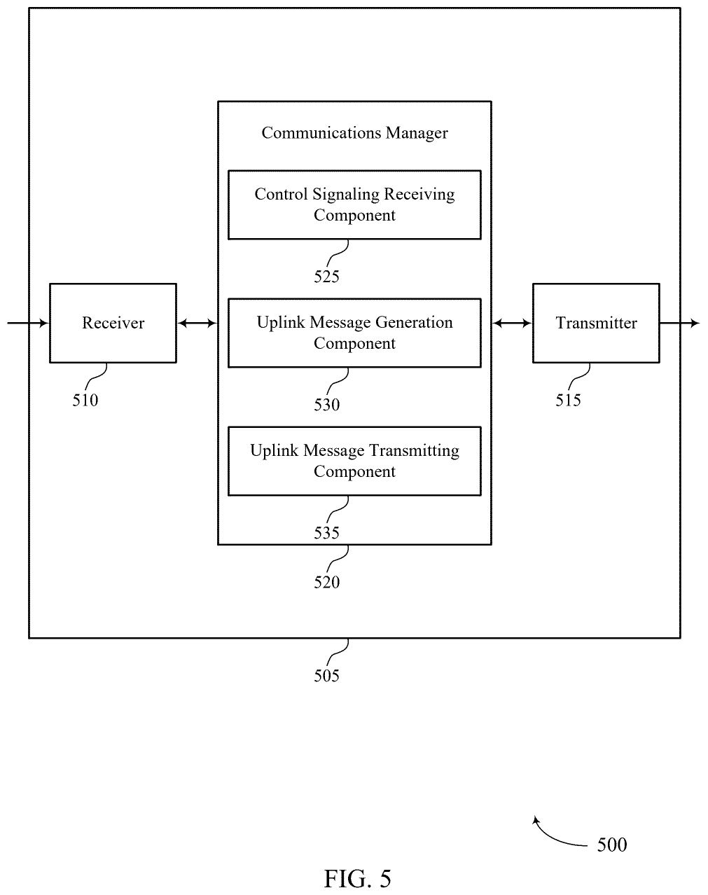

FIG. 5 shows a block diagram 500 of a device 505 that supports techniques for differentiation in HARQ process types in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for differentiation in HARQ process types). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for differentiation in HARQ process types). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for differentiation in HARQ process types as described herein. For example, the communications manager 520 may include a control signaling receiving component 525, an uplink message generation component 530, an uplink message transmitting component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The control signaling receiving component 525 is capable of, configured to, or operable to support a means for receiving, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, correspond to one or more LCHs from a set of multiple LCHs. The uplink message generation component 530 is capable of, configured to, or operable to support a means for generating an uplink message based on the uplink grant and at least one of the uplink grant type or the HARQ process type, where the uplink message includes uplink data associated with the one or more LCHs corresponding to the uplink grant type or the HARQ process type. The uplink message transmitting component 535 is capable of, configured to, or operable to support a means for transmitting, to the network entity, the uplink message based on generating the uplink message.

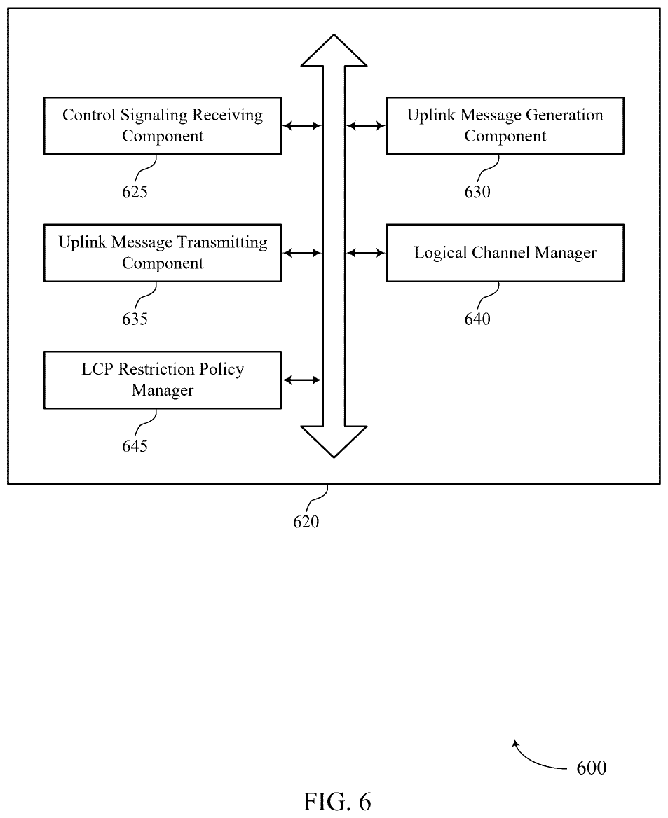

FIG. 6 shows a block diagram 600 of a communications manager 620 that supports techniques for differentiation in HARQ process types in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for differentiation in HARQ process types as described herein. For example, the communications manager 620 may include a control signaling receiving component 625, an uplink message generation component 630, an uplink message transmitting component 635, a LCH manager 640, an LCP restriction policy manager 645, or any combination thereof. Each of these components, or components or subcomponents thereof (e.g., one or more processors, one or more memories), may communicate, directly or indirectly, with one another (e.g., via one or more buses).

The control signaling receiving component 625 is capable of, configured to, or operable to support a means for receiving, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, correspond to one or more LCHs from a set of multiple LCHs. The uplink message generation component 630 is capable of, configured to, or operable to support a means for generating an uplink message based on the uplink grant and at least one of the uplink grant type or the HARQ process type, where the uplink message includes uplink data associated with the one or more LCHs corresponding to the uplink grant type or the HARQ process type. The uplink message transmitting component 635 is capable of, configured to, or operable to support a means for transmitting, to the network entity, the uplink message based on generating the uplink message.

In some examples, the LCH manager 640 is capable of, configured to, or operable to support a means for identifying the one or more LCHs associated with the HARQ process type based on one or more characteristics associated with the one or more LCHs, the uplink data of the one or more LCHs, or both, where generating the uplink message in accordance with the HARQ process type is based on identifying the one or more LCHs associated with the HARQ process type.

In some examples, the control signaling receiving component 625 is capable of, configured to, or operable to support a means for receiving, via the control signaling, an indication of the one or more characteristics, where identifying the one or more LCHs, generating the uplink message, or both, is based on receiving the indication of the one or more characteristics.

In some examples, the one or more characteristics associated with the one or more LCHs include a link quality metric associated with the one or more LCHs.

In some examples, the one or more characteristics associated with the uplink data of the one or more LCHs include a remaining time associated with the uplink data.

In some examples, the LCP restriction policy manager 645 is capable of, configured to, or operable to support a means for receiving a LCP restriction policy associated with the UE, where the LCP restriction policy indicates an association between the set of multiple HARQ process types and corresponding sets of LCHs, where the uplink message is generated in accordance with the LCP restriction policy.

In some examples, each HARQ process type from the set of multiple HARQ process types is associated with a respective set of HARQ transmission parameters.

In some examples, each respective set of HARQ transmission parameters includes at least a quantity of HARQ retransmissions or a BLER metric.

In some examples, the control signaling includes a DCI message, an RRC message, or both.

In some examples, the uplink grant type is associated with a PDU session, where the one or more LCHs correspond to the PDU session. In some examples, the uplink grant type is associated with a network slice, where the one or more LCHs correspond to the network slice. In some examples, the uplink grant type is associated with a delay-sensitive QoS flow, where the one or more LCHs correspond to the delay-sensitive QoS flow.

In some examples, to support receiving the control signaling, the control signaling receiving component 625 is capable of, configured to, or operable to support a means for receiving an RRC message indicating associations between the set of multiple HARQ process types and corresponding sets of LCHs. In some examples, to support receiving the control signaling, the control signaling receiving component 625 is capable of, configured to, or operable to support a means for receiving a DCI message indicating the uplink grant and the HARQ process type from the set of multiple HARQ process types that is to be used for the uplink grant, where generating the uplink message, transmitting the uplink message, or both, is based on receiving the RRC message and the DCI message.

In some examples, to support receiving the control signaling, the control signaling receiving component 625 is capable of, configured to, or operable to support a means for receiving an RRC message indicating a correspondence between the set of multiple uplink grant types usable for wireless communications between the UE and the network entity and a first set of multiple indexes or between the set of multiple HARQ process types and a second set of multiple indexes, or both, where the control signaling indicates the uplink grant type or the HARQ process type based on the control signaling including one or more indexes that correspond to the uplink grant type or the HARQ process type, or both.

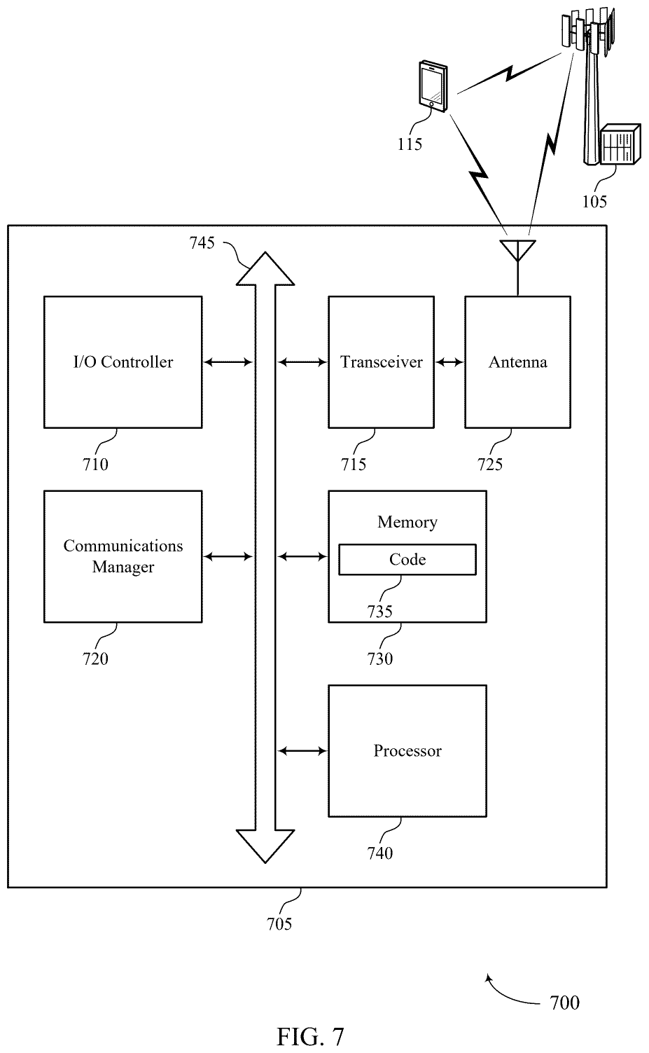

FIG. 7 shows a diagram of a system 700 including a device 705 that supports techniques for differentiation in HARQ process types in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for differentiation in HARQ process types). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for receiving, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, correspond to one or more LCHs from a set of multiple LCHs. The communications manager 720 is capable of, configured to, or operable to support a means for generating an uplink message based on the uplink grant and at least one of the uplink grant type or the HARQ process type, where the uplink message includes uplink data associated with the one or more LCHs corresponding to the uplink grant type or the HARQ process type. The communications manager 720 is capable of, configured to, or operable to support a means for transmitting, to the network entity, the uplink message based on generating the uplink message.

By including or configuring the communications manager 720 in accordance with examples as described herein, the device 705 may support techniques that enable HARQ processes to be tailored to different types of communications or LCHs. For example, XR applications may be configured to utilize a first HARQ process type, and eMBB communications may be configured to utilize a second HARQ process type. In some cases, by defining associations between HARQ process types and corresponding LCHs and/or QoS flows, techniques described herein may resolve ambiguities at a UE as to which HARQ Tx parameters the UE is to use. Additionally, aspects of the present disclosure may facilitate reduced latency and increased throughput for wireless communications by tailoring HARQ process types to different LCHs/QoS flows.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for differentiation in HARQ process types as described herein, or the at least one processor 740 and the at least one memory 730 may be otherwise configured to, individually or collectively, perform or support such operations.

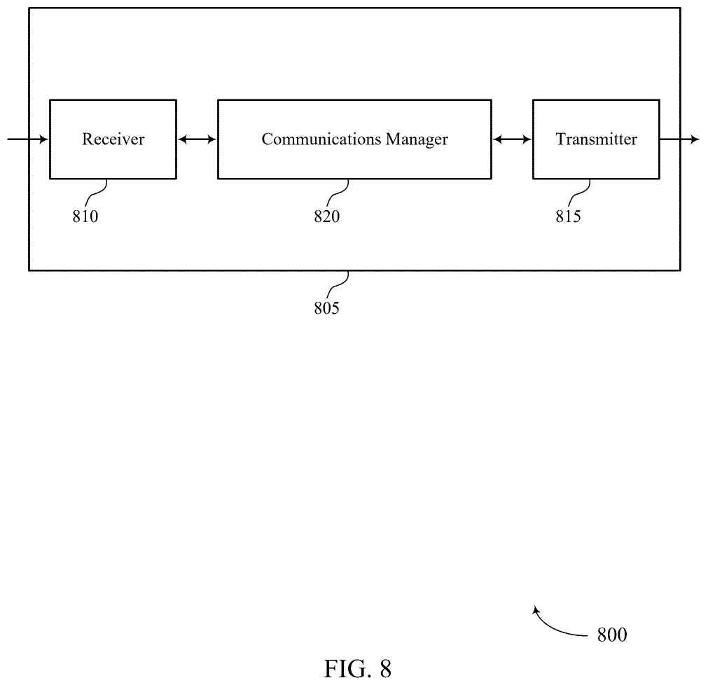

FIG. 8 shows a block diagram 800 of a device 805 that supports techniques for differentiation in HARQ process types in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for differentiation in HARQ process types as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs. The communications manager 820 is capable of, configured to, or operable to support a means for receiving, from the UE, an uplink message based on the uplink grant and at least one of the uplink grant type or the HARQ process type, where the uplink message includes uplink data associated with the one or more LCHs corresponding to the uplink grant type or the HARQ process type.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques that enable HARQ processes to be tailored to different types of communications or LCHs. For example, XR applications may be configured to utilize a first HARQ process type, and eMBB communications may be configured to utilize a second HARQ process type. In some cases, by defining associations between HARQ process types and corresponding LCHs and/or QoS flows, techniques described herein may resolve ambiguities at a UE as to which HARQ Tx parameters the UE is to use. Additionally, aspects of the present disclosure may facilitate reduced latency and increased throughput for wireless communications by tailoring HARQ process types to different LCHs/QoS flows.

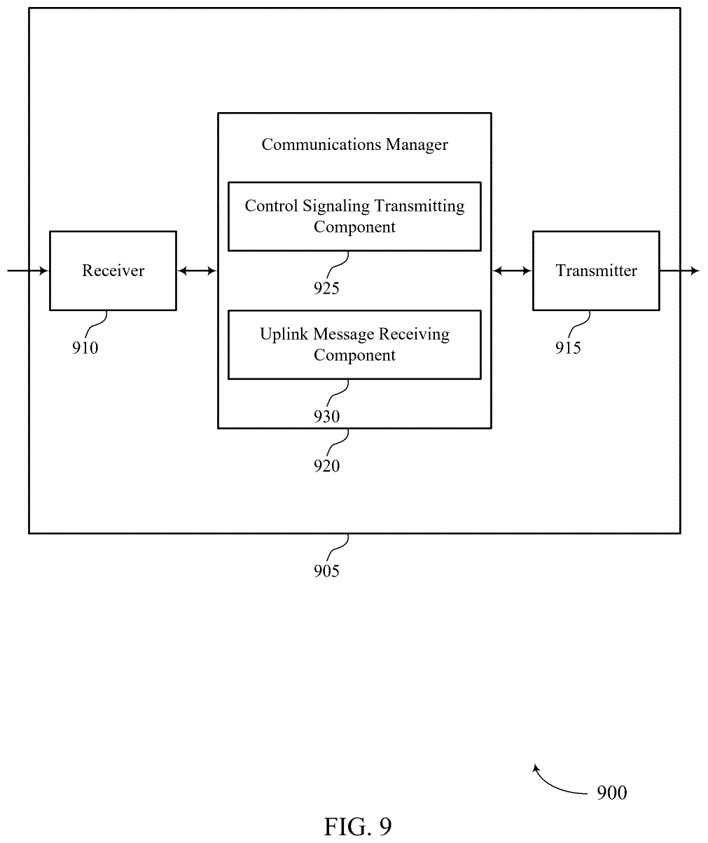

FIG. 9 shows a block diagram 900 of a device 905 that supports techniques for differentiation in HARQ process types in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for differentiation in HARQ process types as described herein. For example, the communications manager 920 may include a control signaling transmitting component 925 an uplink message receiving component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The control signaling transmitting component 925 is capable of, configured to, or operable to support a means for transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs. The uplink message receiving component 930 is capable of, configured to, or operable to support a means for receiving, from the UE, an uplink message based on the uplink grant and at least one of the uplink grant type or the HARQ process type, where the uplink message includes uplink data associated with the one or more LCHs corresponding to the uplink grant type or the HARQ process type.

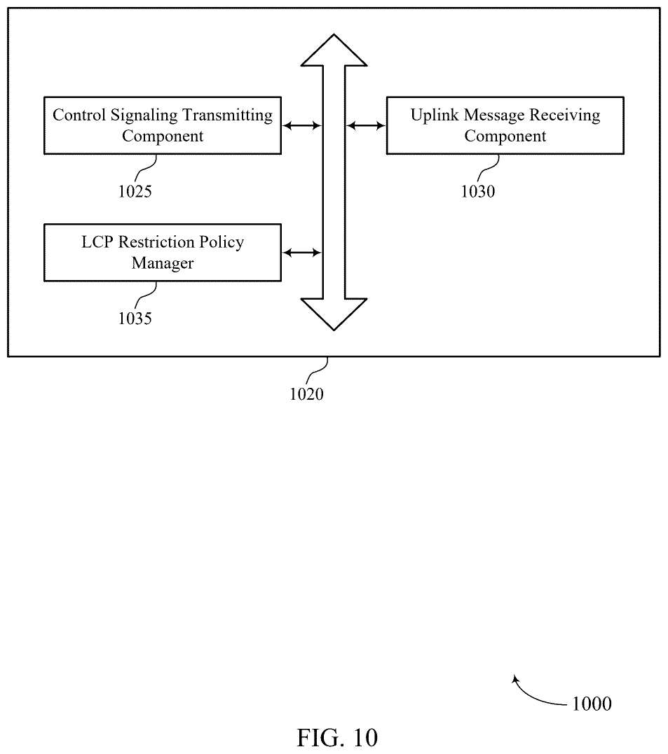

FIG. 10 shows a block diagram 1000 of a communications manager 1020 that supports techniques for differentiation in HARQ process types in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for differentiation in HARQ process types as described herein. For example, the communications manager 1020 may include a control signaling transmitting component 1025, an uplink message receiving component 1030, an LCP restriction policy manager 1035, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a LCH of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The control signaling transmitting component 1025 is capable of, configured to, or operable to support a means for transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs. The uplink message receiving component 1030 is capable of, configured to, or operable to support a means for receiving, from the UE, an uplink message based on the uplink grant and at least one of the uplink grant type or the HARQ process type, where the uplink message includes uplink data associated with the one or more LCHs corresponding to the uplink grant type or the HARQ process type.

In some examples, the one or more LCHs associated with the uplink grant type or the HARQ process type are based on one or more characteristics associated with the one or more LCHs, the uplink data of the one or more LCHs, or both.

In some examples, the control signaling transmitting component 1025 is capable of, configured to, or operable to support a means for transmitting, via the control signaling, an indication of the one or more characteristics, where receiving the uplink message is based on receiving the indication of the one or more characteristics.

In some examples, the one or more characteristics associated with the one or more LCHs include a link quality metric associated with the one or more LCHs.

In some examples, the one or more characteristics associated with the uplink data of the one or more LCHs includes a remaining time associated with the uplink data.

In some examples, the uplink grant type and the one or more LCHs are associated with a PDU session, a network slice, delay-sensitive QoS flow, or any combination thereof.

In some examples, the LCP restriction policy manager 1035 is capable of, configured to, or operable to support a means for transmitting a LCP restriction policy associated with the UE, where the LCP restriction policy indicates an association between the set of multiple HARQ process types and corresponding sets of LCHs, where the uplink message is based on the LCP restriction policy.

In some examples, each HARQ process type from the set of multiple HARQ process types is associated with a respective set of HARQ transmission parameters.

In some examples, each respective set of HARQ transmission parameters includes at least a quantity of HARQ retransmissions or a BLER metric.

In some examples, the control signaling includes a DCI message, an RRC message, or both.

In some examples, to support transmitting the control signaling, the control signaling transmitting component 1025 is capable of, configured to, or operable to support a means for transmitting an RRC message indicating associations between the set of multiple HARQ process types and corresponding sets of LCHs. In some examples, to support transmitting the control signaling, the control signaling transmitting component 1025 is capable of, configured to, or operable to support a means for transmitting a DCI message indicating the uplink grant and the HARQ process type from the set of multiple HARQ process types that is to be used for the uplink grant, where receiving the uplink message is based on transmitting the RRC message and the DCI message.

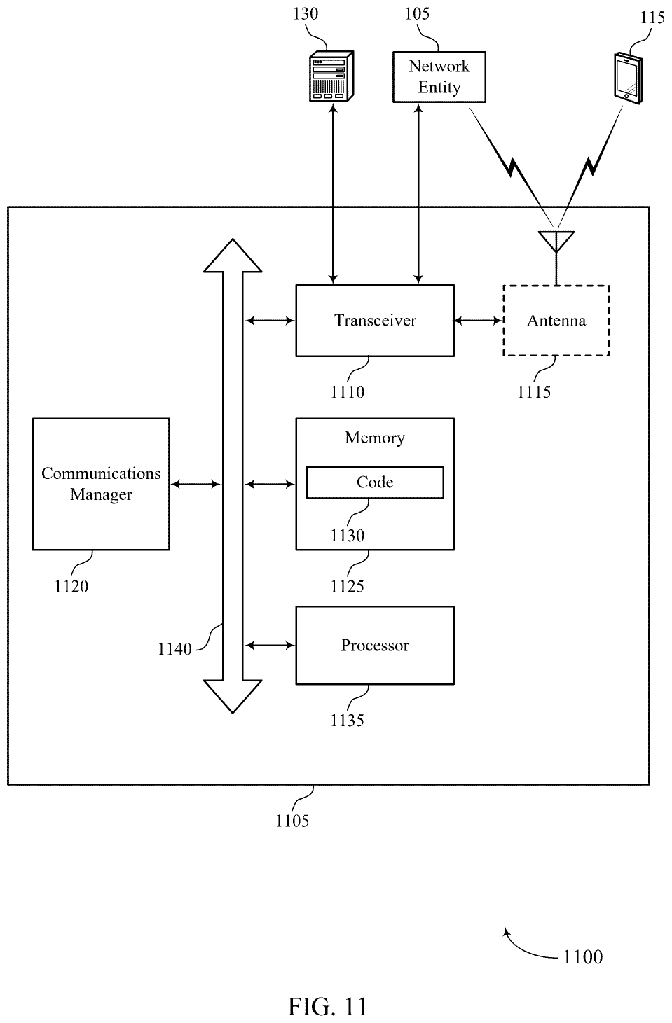

FIG. 11 shows a diagram of a system 1100 including a device 1105 that supports techniques for differentiation in HARQ process types in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for differentiation in HARQ process types). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a LCH of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs. The communications manager 1120 is capable of, configured to, or operable to support a means for receiving, from the UE, an uplink message based on the uplink grant at least one of the uplink grant type or and the HARQ process type, where the uplink message includes uplink data associated with the one or more LCHs corresponding to the uplink grant type or the HARQ process type.

By including or configuring the communications manager 1120 in accordance with examples as described herein, the device 1105 may support techniques that enable HARQ processes to be tailored to different types of communications or LCHs. For example, XR applications may be configured to utilize a first HARQ process type, and eMBB communications may be configured to utilize a second HARQ process type. In some cases, by defining associations between HARQ process types and corresponding LCHs and/or QoS flows, techniques described herein may resolve ambiguities at a UE as to which HARQ Tx parameters the UE is to use. Additionally, aspects of the present disclosure may facilitate reduced latency and increased throughput for wireless communications by tailoring HARQ process types to different LCHs/QoS flows.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for differentiation in HARQ process types as described herein, or the at least one processor 1135 and the at least one memory 1125 may be otherwise configured to, individually or collectively, perform or support such operations.

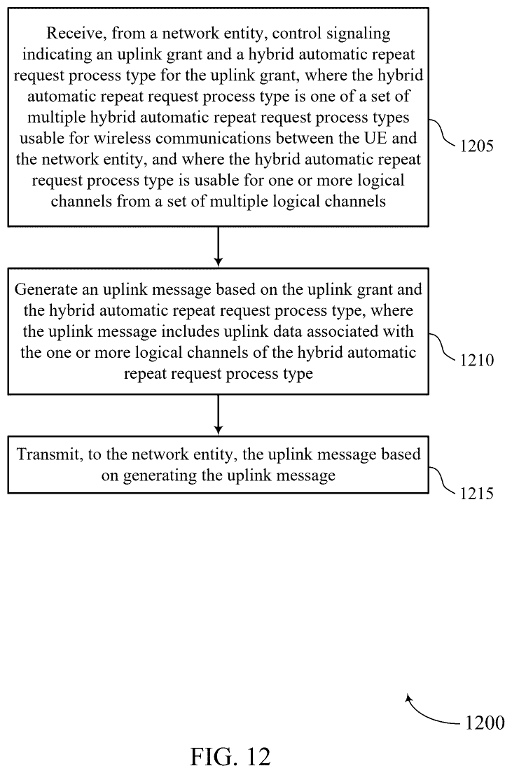

FIG. 12 shows a flowchart illustrating a method 1200 that supports techniques for differentiation in HARQ process types in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, control signaling indicating an uplink grant and a HARQ process type for the uplink grant, where the HARQ process type is one of a set of multiple HARQ process types usable for wireless communications between the UE and the network entity, and where the HARQ process type is usable for one or more LCHs from a set of multiple LCHs. The operations of 1205 may be performed in accordance with examples as disclosed herein. In some examples, aspects of the operations of 1205 may be performed by a control signaling receiving component 625 as described with reference to FIG. 6.

At 1210, the method may include generating an uplink message based on the uplink grant and the HARQ process type, where the uplink message includes uplink data associated with the one or more LCHs of the HARQ process type. The operations of 1210 may be performed in accordance with examples as disclosed herein. In some examples, aspects of the operations of 1210 may be performed by an uplink message generation component 630 as described with reference to FIG. 6.

At 1215, the method may include transmitting, to the network entity, the uplink message based on generating the uplink message. The operations of 1215 may be performed in accordance with examples as disclosed herein. In some examples, aspects of the operations of 1215 may be performed by an uplink message transmitting component 635 as described with reference to FIG. 6.

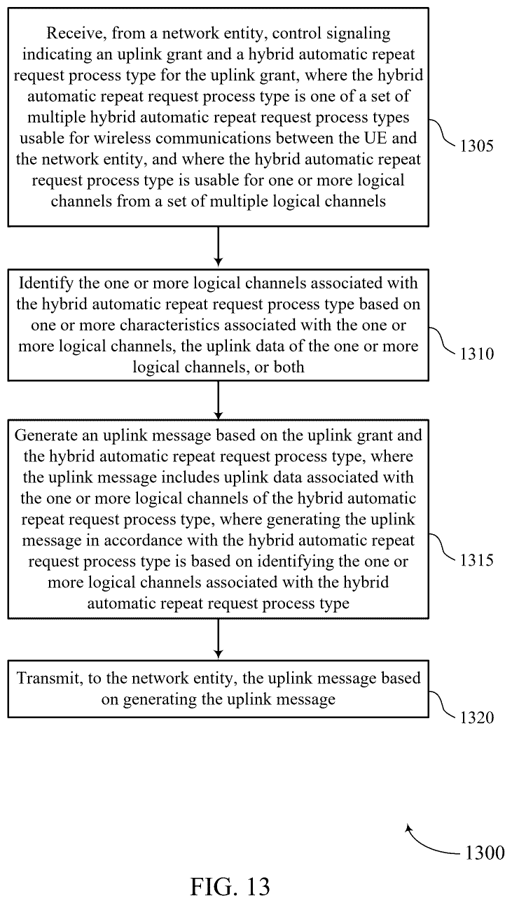

FIG. 13 shows a flowchart illustrating a method 1300 that supports techniques for differentiation in HARQ process types in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, control signaling indicating an uplink grant and a HARQ process type for the uplink grant, where the HARQ process type is one of a set of multiple HARQ process types usable for wireless communications between the UE and the network entity, and where the HARQ process type is usable for one or more LCHs from a set of multiple LCHs. The operations of 1305 may be performed in accordance with examples as disclosed herein. In some examples, aspects of the operations of 1305 may be performed by a control signaling receiving component 625 as described with reference to FIG. 6.

At 1310, the method may include identifying the one or more LCHs associated with the HARQ process type based on one or more characteristics associated with the one or more LCHs, the uplink data of the one or more LCHs, or both. The operations of 1310 may be performed in accordance with examples as disclosed herein. In some examples, aspects of the operations of 1310 may be performed by a LCH manager 640 as described with reference to FIG. 6.

At 1315, the method may include generating an uplink message based on the uplink grant and the HARQ process type, where the uplink message includes uplink data associated with the one or more LCHs of the HARQ process type, where generating the uplink message in accordance with the HARQ process type is based on identifying the one or more LCHs associated with the HARQ process type. The operations of 1315 may be performed in accordance with examples as disclosed herein. In some examples, aspects of the operations of 1315 may be performed by an uplink message generation component 630 as described with reference to FIG. 6.

At 1320, the method may include transmitting, to the network entity, the uplink message based on generating the uplink message. The operations of 1320 may be performed in accordance with examples as disclosed herein. In some examples, aspects of the operations of 1320 may be performed by an uplink message transmitting component 635 as described with reference to FIG. 6.

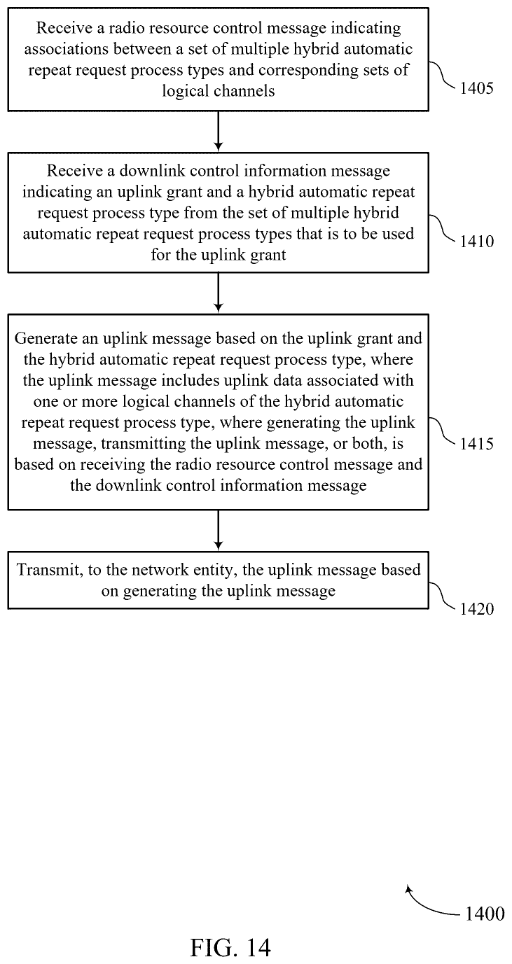

FIG. 14 shows a flowchart illustrating a method 1400 that supports techniques for differentiation in HARQ process types in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving an RRC message indicating associations between a set of multiple HARQ process types and corresponding sets of LCHs. The operations of 1405 may be performed in accordance with examples as disclosed herein. In some examples, aspects of the operations of 1405 may be performed by a control signaling receiving component 625 as described with reference to FIG. 6.

At 1410, the method may include receiving a DCI message indicating an uplink grant and a HARQ process type from the set of multiple HARQ process types that is to be used for the uplink grant, where generating the uplink message, transmitting the uplink message, or both, is based on receiving the RRC message and the DCI message. The operations of 1410 may be performed in accordance with examples as disclosed herein. In some examples, aspects of the operations of 1410 may be performed by a control signaling receiving component 625 as described with reference to FIG. 6.

At 1415, the method may include generating an uplink message based on the uplink grant and the HARQ process type, where the uplink message includes uplink data associated with one or more LCHs of the HARQ process type where generating the uplink message, transmitting the uplink message, or both, is based on receiving the RRC message and the DCI message. The operations of 1415 may be performed in accordance with examples as disclosed herein. In some examples, aspects of the operations of 1415 may be performed by an uplink message generation component 630 as described with reference to FIG. 6.

At 1420, the method may include transmitting, to the network entity, the uplink message based on generating the uplink message. The operations of 1420 may be performed in accordance with examples as disclosed herein. In some examples, aspects of the operations of 1420 may be performed by an uplink message transmitting component 635 as described with reference to FIG. 6.

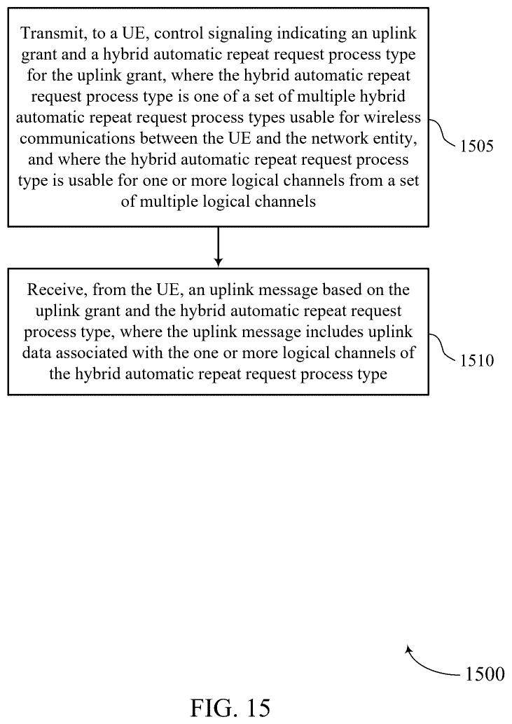

FIG. 15 shows a flowchart illustrating a method 1500 that supports techniques for differentiation in HARQ process types in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, control signaling indicating an uplink grant and a HARQ process type for the uplink grant, where the HARQ process type is one of a set of multiple HARQ process types usable for wireless communications between the UE and the network entity, and where the HARQ process type is usable for one or more LCHs from a set of multiple LCHs. The operations of 1505 may be performed in accordance with examples as disclosed herein. In some examples, aspects of the operations of 1505 may be performed by a control signaling transmitting component 1025 as described with reference to FIG. 10.

At 1510, the method may include receiving, from the UE, an uplink message based on the uplink grant and the HARQ process type, where the uplink message includes uplink data associated with the one or more LCHs of the HARQ process type. The operations of 1510 may be performed in accordance with examples as disclosed herein. In some examples, aspects of the operations of 1510 may be performed by an uplink message receiving component 1030 as described with reference to FIG. 10.

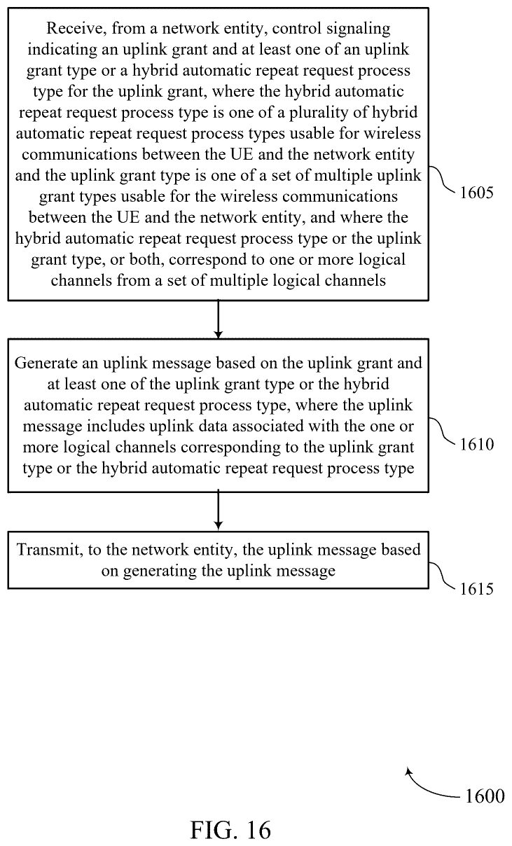

FIG. 16 shows a flowchart illustrating a method 1600 that supports techniques for differentiation in HARQ process types in accordance with one or more aspects of the present disclosure. The operations of the method 1600 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs. The operations of 1605 may be performed in accordance with examples as disclosed herein. In some examples, aspects of the operations of 1605 may be performed by a control signaling receiving component 625 as described with reference to FIG. 6.

At 1610, the method may include generating an uplink message based on the uplink grant and at least one of the uplink grant type or the HARQ process type, where the uplink message includes uplink data associated with the one or more LCHs corresponding to the uplink grant type or the HARQ process type. The operations of 1610 may be performed in accordance with examples as disclosed herein. In some examples, aspects of the operations of 1610 may be performed by an uplink message generation component 630 as described with reference to FIG. 6.

At 1615, the method may include transmitting, to the network entity, the uplink message based on generating the uplink message. The operations of 1615 may be performed in accordance with examples as disclosed herein. In some examples, aspects of the operations of 1615 may be performed by an uplink message transmitting component 635 as described with reference to FIG. 6.

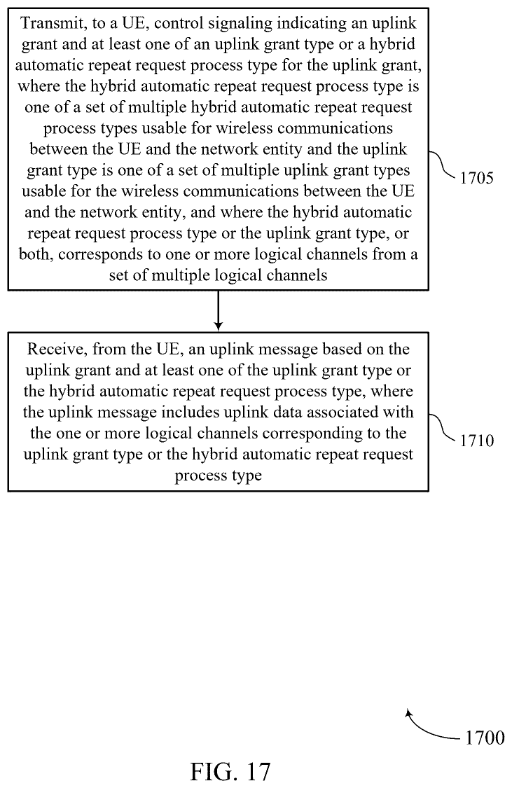

FIG. 17 shows a flowchart illustrating a method 1700 that supports techniques for differentiation in HARQ process types in accordance with one or more aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, control signaling indicating an uplink grant and at least one of an uplink grant type or a HARQ process type for the uplink grant, where the HARQ process type is one of a set of multiple HARQ process types usable for wireless communications between the UE and the network entity and the uplink grant type is one of a set of multiple uplink grant types usable for the wireless communications between the UE and the network entity, and where the HARQ process type or the uplink grant type, or both, corresponds to one or more LCHs from a set of multiple LCHs. The operations of 1705 may be performed in accordance with examples as disclosed herein. In some examples, aspects of the operations of 1705 may be performed by a control signaling transmitting component 1025 as described with reference to FIG. 10.

At 1710, the method may include receiving, from the UE, an uplink message based on the uplink grant and at least one of the uplink grant type or the HARQ process type, where the uplink message includes uplink data associated with the one or more LCHs corresponding to the uplink grant type or the HARQ process type. The operations of 1710 may be performed in accordance with examples as disclosed herein. In some examples, aspects of the operations of 1710 may be performed by an uplink message receiving component 1030 as described with reference to FIG. 10.

The following provides an overview of aspects of the present disclosure:

Aspect 1: A method for wireless communications at a UE, comprising: receiving, from a network entity, control signaling indicating an uplink grant and at least one of an uplink grant type or a HARQ process type for the uplink grant, wherein the HARQ process type is one of a plurality of HARQ process types usable for wireless communications between the UE and the network entity and the uplink grant type is one of a set of multiple uplink grant types usable for the wireless communications between the UE and the network entity, and wherein the HARQ process type or the uplink grant type, or both, correspond to one or more LCHs from a plurality of LCHs; generating an uplink message based at least in part on the uplink grant and at least one of the uplink grant type or the HARQ process type, wherein the uplink message includes uplink data associated with the one or more LCHs corresponding to the uplink grant type or the HARQ process type; and transmitting, to the network entity, the uplink message based at least in part on generating the uplink message.

Aspect 2: The method of aspect 1, further comprising: identifying the one or more LCHs associated with the uplink grant type or the HARQ process type based at least in part on one or more characteristics associated with the one or more LCHs, the uplink data of the one or more LCHs, or both, wherein generating the uplink message in accordance with at least one of the uplink grant type or the HARQ process type is based at least in part on identifying the one or more LCHs corresponding to the uplink grant type or the HARQ process type.

Aspect 3: The method of aspect 2, further comprising: receiving, via the control signaling, an indication of the one or more characteristics, wherein identifying the one or more LCHs, generating the uplink message, or both, is based at least in part on receiving the indication of the one or more characteristics.

Aspect 4: The method of any of aspects 2 through 3, wherein the one or more characteristics associated with the one or more LCHs comprise a link quality metric associated with the one or more LCHs.

Aspect 5: The method of any of aspects 2 through 4, wherein the one or more characteristics associated with the uplink data of the one or more LCHs comprise a remaining time associated with the uplink data.

Aspect 6: The method of any of aspects 1 through 5, further comprising: receiving a LCP restriction policy associated with the UE, wherein the LCP restriction policy indicates an association between the plurality of HARQ process types and corresponding sets of LCHs, wherein the uplink message is generated in accordance with the LCP restriction policy.

Aspect 7: The method of any of aspects 1 through 6, wherein each HARQ process type from the plurality of HARQ process types is associated with a respective set of HARQ transmission parameters.

Aspect 8: The method of aspect 7, wherein each respective set of HARQ transmission parameters comprises at least a quantity of HARQ retransmissions or a BLER metric.

Aspect 9: The method of any of aspects 1 through 8, wherein the control signaling comprises a DCI message, an RRC message, or both.

Aspect 10: The method of any of aspects 1 through 9, wherein receiving the control signaling comprises: receiving an RRC message indicating associations between the plurality of HARQ process types and corresponding sets of LCHs; and receiving a DCI message indicating the uplink grant and the HARQ process type from the plurality of HARQ process types that is to be used for the uplink grant, wherein generating the uplink message, transmitting the uplink message, or both, is based at least in part on receiving the RRC message and the DCI message.

Aspect 11: A method for wireless communications at a network entity, comprising: transmitting, to a UE, control signaling indicating an uplink grant and at least one of an uplink grant type or a HARQ process type for the uplink grant, wherein the HARQ process type is one of a plurality of HARQ process types usable for wireless communications between the UE and the network entity and the uplink grant type is one of a plurality of uplink grant types usable for the wireless communications between the UE and the network entity, and wherein the HARQ process type or the uplink grant type, or both, corresponds to one or more LCHs from a plurality of LCHs; and receiving, from the UE, an uplink message based at least in part on the uplink grant and at least one of the uplink grant type or the HARQ process type, wherein the uplink message includes uplink data associated with the one or more LCHs corresponding to the uplink grant type or the HARQ process type.

Aspect 12: The method of aspect 11, wherein the one or more LCHs associated with the uplink grant type or the HARQ process type are based at least in part on one or more characteristics associated with the one or more LCHs, the uplink data of the one or more LCHs, or both.

Aspect 13: The method of aspect 12, further comprising: transmitting, via the control signaling, an indication of the one or more characteristics, wherein receiving the uplink message is based at least in part on receiving the indication of the one or more characteristics.

Aspect 14: The method of any of aspects 12 through 13, wherein the one or more characteristics associated with the one or more LCHs comprise a link quality metric associated with the one or more LCHs.

Aspect 15: The method of any of aspects 12 through 14, wherein the one or more characteristics associated with the uplink data of the one or more LCHs comprises a remaining time associated with the uplink data.

Aspect 16: The method of any of aspects 11 through 15, further comprising: transmitting a LCP restriction policy associated with the UE, wherein the LCP restriction policy indicates an association between the plurality of HARQ process types and corresponding sets of LCHs, wherein the uplink message is based at least in part on the LCP restriction policy.

Aspect 17: The method of any of aspects 11 through 16, wherein each HARQ process type from the plurality of HARQ process types is associated with a respective set of HARQ transmission parameters.

Aspect 18: The method of aspect 17, wherein each respective set of HARQ transmission parameters comprises at least a quantity of HARQ retransmissions or a BLER metric.

Aspect 19: The method of any of aspects 11 through 18, wherein the control signaling comprises a DCI message, an RRC message, or both.

Aspect 20: The method of any of aspects 11 through 19, wherein transmitting the control signaling comprises: transmitting an RRC message indicating associations between the plurality of HARQ process types and corresponding sets of LCHs; and transmitting a DCI message indicating the uplink grant and the HARQ process type from the plurality of HARQ process types that is to be used for the uplink grant, wherein receiving the uplink message is based at least in part on transmitting the RRC message and the DCI message.

Aspect 21: The method of any of aspects 1 through 10, wherein the uplink grant type is associated with a PDU session, wherein the one or more logical channels correspond to the PDU session.

Aspect 22: The method of any of aspects 1 through 10 or 21, wherein the uplink grant type is associated with a network slice, wherein the one or more logical channels correspond to the network slice.

Aspect 23: The method of any of aspects 1 through 10 or aspects 21 through 22, wherein the uplink grant type is associated with a delay-sensitive QoS flow, wherein the one or more logical channels correspond to the delay-sensitive QoS flow.

Aspect 24: The method of any of aspects 1 through 10 or aspects 21 through 23, further comprising: receiving an RRC message indicating a correspondence between the plurality of uplink grant types usable for wireless communications between the UE and the network entity and a first plurality of indexes or between the plurality of HARQ process types and a second plurality of indexes, or both, wherein the control signaling indicates the uplink grant type or the HARQ process type based at least in part on the control signaling comprising one or more indexes that correspond to the uplink grant type or the HARQ process type, or both.

Aspect 25: The method of any of aspects 11 through 20, wherein the uplink grant type and the one or more logical channels are associated with a PDU session, a network slice, delay-sensitive QoS flow, or any combination thereof.

Aspect 26: A UE comprising one or more memories storing processor-executable code, and one or more processors coupled with the one or more memories and individually or collectively operable to execute the code to cause the UE to perform a method of any of aspects 1 through 10 or aspects 21 through 24.

Aspect 27: A UE comprising at least one means for performing a method of any of aspects 1 through 10 or aspects 21 through 24.

Aspect 28: A non-transitory computer-readable medium storing code the code comprising instructions executable by one or more processors to perform a method of any of aspects 1 through 10 or aspects 21 through 24.

Aspect 29: A network entity for wireless communications, comprising one or more memories storing processor-executable code, and one or more processors coupled with the one or more memories and individually or collectively operable to execute the code to cause the network entity to perform a method of any of aspects 11 through 20 or aspect 25.

Aspect 30: A network entity for wireless communications, comprising at least one means for performing a method of any of aspects 11 through 20 or aspect 25.

Aspect 31: A non-transitory computer-readable medium storing code for wireless communications, the code comprising instructions executable by one or more processors to perform a method of any of aspects 11 through 20 or aspect 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, control signaling indicating an uplink grant and at least one of an uplink grant type or a hybrid automatic repeat request process type for the uplink grant, wherein the hybrid automatic repeat request process type is one of a plurality of hybrid automatic repeat request process types usable for wireless communications between the UE and the network entity and the uplink grant type is one of a plurality of uplink grant types usable for the wireless communications between the UE and the network entity, and wherein the hybrid automatic repeat request process type or the uplink grant type, or both, correspond to one or more logical channels from a plurality of logical channels;
generate an uplink message based at least in part on the uplink grant and at least one of the uplink grant type or the hybrid automatic repeat request process type, wherein the uplink message includes uplink data associated with the one or more logical channels corresponding to the uplink grant type or the hybrid automatic repeat request process type; and
transmit, to the network entity, the uplink message based at least in part on generating the uplink message.

2. The UE of claim 1, wherein the one or more processors are individually or collectively further operable to execute the code to cause the UE to:
identify the one or more logical channels associated with the uplink grant type or the hybrid automatic repeat request process type based at least in part on one or more characteristics associated with the one or more logical channels, the uplink data of the one or more logical channels, or both, wherein generating the uplink message in accordance with at least one of the uplink grant type or the hybrid automatic repeat request process type is based at least in part on identifying the one or more logical channels corresponding to the uplink grant type or the hybrid automatic repeat request process type.

3. The UE of claim 2, wherein the one or more processors are individually or collectively further operable to execute the code to cause the UE to:
receive, via the control signaling, an indication of the one or more characteristics, wherein identifying the one or more logical channels, generating the uplink message, or both, is based at least in part on receiving the indication of the one or more characteristics.

4. The UE of claim 2, wherein the one or more characteristics associated with the one or more logical channels comprise a link quality metric associated with the one or more logical channels.

5. The UE of claim 2, wherein the one or more characteristics associated with the uplink data of the one or more logical channels comprise a remaining time associated with the uplink data.

6. The UE of claim 1, wherein the one or more processors are individually or collectively further operable to execute the code to cause the UE to:
receive a logical channel prioritization restriction policy associated with the UE, wherein the logical channel prioritization restriction policy indicates an association between the plurality of hybrid automatic repeat request process types and corresponding sets of logical channels, wherein the uplink message is generated in accordance with the logical channel prioritization restriction policy.

7. The UE of claim 1, wherein each hybrid automatic repeat request process type from the plurality of hybrid automatic repeat request process types is associated with a respective set of hybrid automatic repeat request transmission parameters.

8. The UE of claim 7, wherein each respective set of hybrid automatic repeat request transmission parameters comprises at least a quantity of hybrid automatic repeat request retransmissions or a block error rate metric.

9. The UE of claim 1, wherein the control signaling comprises a downlink control information message, a radio resource control message, or both.

10. The UE of claim 1, wherein, to receive the control signaling, the one or more processors are individually or collectively operable to execute the code to cause the UE to:
receive a radio resource control message indicating associations between the plurality of hybrid automatic repeat request process types and corresponding sets of logical channels; and
receive a downlink control information message indicating the uplink grant and the hybrid automatic repeat request process type from the plurality of hybrid automatic repeat request process types that is to be used for the uplink grant, wherein generating the uplink message, transmitting the uplink message, or both, is based at least in part on receiving the radio resource control message and the downlink control information message.

11. The UE of claim 1, wherein the uplink grant type is associated with a Packet Data Unit (PDU) session, wherein the one or more logical channels correspond to the PDU session.

12. The UE of claim 1, wherein the uplink grant type is associated with a network slice, wherein the one or more logical channels correspond to the network slice.

13. The UE of claim 1, wherein the uplink grant type is associated with a delay-sensitive quality of service (QoS) flow, wherein the one or more logical channels correspond to the delay-sensitive QoS flow.

14. The UE of claim 1, further comprising:
receive a radio resource control message indicating a correspondence between the plurality of uplink grant types usable for wireless communications between the UE and the network entity and a first plurality of indexes or between the plurality of hybrid automatic repeat request process types and a second plurality of indexes, or both, wherein the control signaling indicates the uplink grant type or the hybrid automatic repeat request process type based at least in part on the control signaling comprising one or more indexes that correspond to the uplink grant type or the hybrid automatic repeat request process type, or both.

15. A network entity, comprising:
one or more memories storing processor-executable code; and
one or more processors coupled with the one or more memories and individually or collectively operable to execute the code to cause the network entity to:
transmit, to a user equipment (UE), control signaling indicating an uplink grant and at least one of an uplink grant type or a hybrid automatic repeat request process type for the uplink grant, wherein the hybrid automatic repeat request process type is one of a plurality of hybrid automatic repeat request process types usable for wireless communications between the UE and the network entity and the uplink grant type is one of a plurality of uplink grant types usable for the wireless communications between the UE and the network entity, and wherein the hybrid automatic repeat request process type or the uplink grant type, or both, corresponds to one or more logical channels from a plurality of logical channels; and
receive, from the UE, an uplink message based at least in part on the uplink grant and at least one of the uplink grant type or the hybrid automatic repeat request process type, wherein the uplink message includes uplink data associated with the one or more logical channels corresponding to the uplink grant type or the hybrid automatic repeat request process type.

16. The network entity of claim 15, wherein the one or more logical channels associated with the uplink grant type or the hybrid automatic repeat request process type are based at least in part on one or more characteristics associated with the one or more logical channels, the uplink data of the one or more logical channels, or both.

17. The network entity of claim 16, wherein the one or more processors are individually or collectively further operable to execute the code to cause the network entity to:
transmit, via the control signaling, an indication of the one or more characteristics, wherein receiving the uplink message is based at least in part on receiving the indication of the one or more characteristics.

18. The network entity of claim 15, wherein the uplink grant type and the one or more logical channels are associated with a Packet Data Unit (PDU) session, a network slice, delay-sensitive Quality of Service (QoS) flow, or any combination thereof.

19. The network entity of claim 15, wherein the one or more processors are individually or collectively further operable to execute the code to cause the network entity to:
transmit a logical channel prioritization restriction policy associated with the UE, wherein the logical channel prioritization restriction policy indicates an association between the plurality of hybrid automatic repeat request process types and corresponding sets of logical channels, wherein the uplink message is based at least in part on the logical channel prioritization restriction policy.

20. A method for wireless communications at a user equipment (UE), comprising:
receiving, from a network entity, control signaling indicating an uplink grant and at least one of an uplink grant type or a hybrid automatic repeat request process type for the uplink grant, wherein the hybrid automatic repeat request process type is one of a plurality of hybrid automatic repeat request process types usable for wireless communications between the UE and the network entity and the uplink grant type is one of a plurality of uplink grant types usable for the wireless communications between the UE and the network entity, and wherein the hybrid automatic repeat request process type is usable for one or more logical channels from a plurality of logical channels;
generating an uplink message based at least in part on the uplink grant and at least one of the uplink grant type or the hybrid automatic repeat request process type, wherein the uplink message includes uplink data associated with the one or more logical channels corresponding to the uplink grant type or the hybrid automatic repeat request process type; and
transmitting, to the network entity, the uplink message based at least in part on generating the uplink message.
